(19) United States
(12) Patent Application Publication
(10) Pub. No.: US 2014/0254223 A1
(43) Pub. Date: Sep. 11, 2014

(54) METHOD AND SYSTEM FOR A HIGH SPEED SOFT-SWITCHING RESONANT CONVERTER

(71) Applicant: Rudolf Limpaecher, Sarasota, FL (US)

(72) Inventor: Rudolf Limpaecher, Sarasota, FL (US)

(21) Appl. No.: 13/788,718

(22) Filed: Mar. 7, 2013

(51) Int. Cl. H02M 7/06

(52) U.S. Cl. CPC H02M 7/06
USPC 363/126

(57) ABSTRACT

A high power and high frequency resonant converter topology and control system operates in a configuration and mode that significantly reduces the voltage on the solid-state switches while retaining the soft switching features.

### BACKGROUND

This invention relates to soft switching resonant power converters.

It is widely acknowledged that the future of electric transmission and distribution grids requires a greater flexibility and faster response than the present AC system for improved voltage, power, and fault protection control. While knowledge of how to optimally control the grid exists, optimal grid control requires efficient power control equipment for instantaneous power routing, regulated voltage, regulation power, and reactive power control (VAR) which are not currently available.

With the availability of solid-state devices, the majority of present day converters have the flexibility for low voltage operation. However, Hard Switching (HS) converter topologies result in large losses with medium and high voltage switching devices.

Some resonant converters, such as the resonant converter described in U.S. Pat. No. 6,118,678 (hereinafter referred to as “678 patent”), are Soft Switching (SS) and have practically no or minimum switching losses. However, such resonant converters require nearly double, and for some applications, even higher switch voltage rating. To address medium and higher voltage applications, series switches are required, these typical SS converters require nearly double the number of solid-state series connected devices with the associated losses per switching stage and added cost.

### SUMMARY

In an embodiment, in general, a high power and high frequency resonant converter topology and control system operates in a mode that significantly reduces the voltage on the solid-state switches while retaining the soft switching features. High voltage Silicon and Silicon Carbide switches can be used in the construction of high voltage converters for military, utility, and commercial application yielding minimum losses, a high converter frequency of operation, no or insignificant switching losses, and reliable operation. The topology may use thyristors or controlled opening switch requiring no forced commutation or high dI/dt, thus significantly reducing electromagnetic interference (EMI) and electromagnetic compatibility (EMC). This circuit topology and its control technology is applicable for high, medium, and low voltage AC and DC transmission and transformation converters changing directly AC to AC, AC to DC, DC to AC, DC to DC without a DC link. Using a single phase high frequency transformer, operating at the converter frequency, yields a high power density. The output can be stepped-up or stepped-down, eliminating the large and standard line frequency transformers. The topology also can be used as a VAR compensator and/or a harmonic mitigator with a direct connection to the AC grid.

In one general aspect, a method of transferring electric charge between a first power terminal having a plurality of first-nodes and a second power terminal having a plurality of second-nodes includes interchanging charges between a first first-node of the plurality of first-nodes with a resonant circuit, the resonant circuit including a storage device and a series connected inductive section. When a predetermined charge has been interchanged between the first first-node and the resonant circuit, the first first-node is replaced by a second first-node of the plurality of first-nodes and charges are interchanged between the second first-node and the resonant circuit. When a predetermined charge has been interchanged between the second first-node and the resonant circuit, the second first-node is replaced by a first second-node of the plurality of second-nodes. When a predetermined charge has been interchanged between the first second-node and the resonant circuit, the first second-node is replaced by a second second-node of the plurality of second-nodes and charges are interchanged between the second second-node and the resonant circuit.

Aspects may include one or more of the following features.

The first power terminal may be configured as an AC power terminal and the second power terminal may be configured as an AC power terminal. The first power terminal may be configured as an AC power terminal and the second power terminal may be configured as a DC power terminal. The first power terminal may be configured as a DC power terminal and the second power terminal may be configured as an AC power terminal. The first power terminal may be configured as a DC power terminal and the second power terminal may be configured as a DC power terminal.

The first power terminal and the second power terminal may be the same power terminal. Some aspects further comprise a plurality of power terminals including the first power terminal and the second power terminal where the charge interchange between the resonant circuit and the first power terminal can be taken between any one of the plurality of power terminals and the resonant circuit, and the charge interchange between the resonant circuit and the second power terminal can be taken place between any one of the plurality of power terminals and the resonant circuit. In some aspects, the charge interchange between the resonant circuit and the first power terminal is alternated with the charge interchange between the resonant circuit and the second power terminal.

The energy storage device of resonant circuit may include of a plurality of capacitors. The energy storage device of the resonant circuit may include a single capacitor. The inductive section of the resonant circuit may include a plurality of inductors. The inductive section of the resonant circuit may include a single inductor. The resonant circuit may include a plurality of storage devices and plurality inductive sections. A passive voltage limiter may be connected in parallel to the resonant circuit. An active voltage limiter may be connected in parallel to the resonant circuit.

The ratio of the predetermined charge interchange between the resonant circuit and the first second-node and the charge interchange between the resonant circuit and the second second-node may be equal to the ratio of the current injected into the first second-node and the second second-node. In some aspects a second resonant circuit is included and interchanging charge may occur between the plurality of the power terminals and the second resonant circuit, and the second resonant circuit may be sized to store sufficient energy to serve as an energy sink and source for a plurality of charge interchanges.

In some aspects, the total charge interchange from the first terminal with the resonant circuit can be controlled by adding an additional charge interchange with a low voltage source, preceding the charge interchange between the resonant circuit and a first first-node of the plurality of first-nodes; when a predetermined charge has passed through that low voltage source, replacing the low voltage source with that of the first first-node.

The low voltage power source can have a zero voltage. In some aspects, the total second terminal charge interchange with the resonant circuit can be controlled by adding an additional charge interchange with a low voltage source, when a predetermined charge has passed through second second-node replacing the second second-node with that of a low voltage source. The low voltage power source can have a zero voltage.

In another general aspect, a charge transfer apparatus includes an inductive section, an energy storage device coupled in series with the inductive section to a resonant circuit, a first power terminal having a plurality of first nodes, a plurality of first switches coupling the first power terminal with the resonant circuit, a second power terminal having a plurality of second nodes, a plurality of switches coupling the second power terminal with the resonant circuit, a control unit for controlling the operation of the plurality of first switches to interchange a first predetermined amount of charge between a first node of the plurality of first nodes and the resonant circuit and to interchange a second predetermined amount of charge between a second node of the plurality of first nodes and the resonant circuit, wherein the ratio of the first predetermined amount of charge interchanged between the resonant circuit and the first node and the second predetermined amount of charge interchange between the resonant circuit and the second node is equal to the ratio of the currents drawn from the first node and the second node, and a control unit for controlling the operation of the plurality of second switches to interchange a first predetermined amount of charge between a first second-node of the plurality of second nodes and the resonant circuit and to interchange a second predetermined amount of charge between a second second-node of the plurality of second nodes and the resonant circuit wherein the ratio of the third predetermined amount of charge interchanged between the resonant circuit and the first node and the fourth predetermined amount of charge interchange between the resonant circuit and the second node is equal to the ratio of the currents delivered to the first node and the second node.

Aspects may include one or more of the following features.

The control unit can smoothly transition the charge interchange between the series resonant circuit and the first nodes to the charge interchange between the series resonant circuit and the second nodes. The charge transferred from the first power terminal to the resonant circuit can be alternately followed by change transferred from the resonant circuit to the second power terminal. The first power terminal can be configured to receive a multi-phase power supply and the second power terminal can be configured to supply a multi-phase power load. The control unit can operate the plurality of second switches to reconstruct an AC waveform on the second power terminal. The first power terminal can be configured to receive a DC power supply and the second power terminal can be configured to supply a multi-phase AC load.

The first power terminal can be configured to receive a DC power supply and the second power terminal can be configured to supply a DC load. The first power terminal can be configured to receive a multi-phase AC power supply, and the control unit can operate the plurality of switches to produce an average current described in a Fourier series. One of the Fourier components can be such that the average current is in phase with the voltage of the multi-phase AC power supply. One of the Fourier components can be such that the average current is out of phase by 90 electrical degrees with the voltage of the multi-phase AC power supply. One of the Fourier components can be a harmonic of the fundamental frequency of the multi-phase AC power supply such that the average current yields a harmonic current flow component. The first power terminal and the second power terminal can be the same and coupled to an AC grid, and the control unit can operate the plurality of first switches and the plurality of the second switches to control the reactive current flow to the AC grid.

To control the input power, an inversion switch can be placed across the resonant circuit and the control unit can trigger the inversion to cause a current flow in the resonant circuit prior two the charge interchange with the first power terminal. To control the output power, a reversal switch can be placed across the resonant circuit; and the control unit can trigger the reversal switch to cause a current flow between the resonant circuit and the reversal switch, terminating the charge interchange between the resonant circuit and the second power terminal. In some aspects, the method can implement an electronic transformer, including adding a transformer between the resonant circuit and the plurality of second nodes connecting plurality of switch between the resonant circuit and the primary winding of that transformer; where the transformer secondary is connected to the switches of the second power terminal; and where the control system is operated that switches in conjunction with the plurality of the second switches.

The first power terminal can be configured to receive a multi-phase power supply and the second power terminal can be configured to supply a multi-phase power load. The first power terminal can be configured to receive a DC power supply and the second power terminal can be configured to supply a multi-phase power load. The first power terminal can be configured to receive a multi-phase power supply and the second power terminal can be configured to supply a DC power load. The first power terminal can be configured to receive a DC power supply and the second power terminal can be configured to supply a DC power load. The apparatus may include a transformer with multiple secondary winding, where each winding can be configured as separate power source and a control system controlling the charge transfer to the plurality of power sources. A plurality of secondary power sources can be DC power sources.

A plurality of the power sources can be DC power sources, wherein the DC power sources are connected in series and a control system that controls the plurality of switches to yield a high voltage DC power source. A plurality of the power sources can be DC power sources, and a plurality of the power sources can be AC power sources, and a control system can control the plurality of switches to yield a plurality of isolated AC power sources and plurality of isolated DC power sources. A plurality of switches can be used between the resonant circuit of the primary transformer winding and a control system can be used to switch the resonant circuit to the primary winding periodically reversing the polarity of the primary transformer winding and with it the flux in the transformer core.

A plurality of primary transformer windings can be used and a control system can be used to switch the resonant circuit periodically to alternate the current in that plurality of that windings and with it alternate the flux in the transformer core.

The apparatus can include a transformer with a plurality of primary windings and a plurality of resonant circuits complete with a dedicated plurality of first switches and a plurality of switches for switching each resonant circuit to a primary winding; and wherein the winding directing is such that the flux in the core is periodically reveres; and a control system that alternately charge and discharges the resonant circuit of that plurality of resonant circuit and alternately discharges the resonant circuit into the primary of the primary transformer windings.

In another aspect in general, a method of transferring electric charge between a first power terminal having a first plurality of terminals and a second power terminal having a second plurality of terminals includes electrically connecting a first pair of terminals of the first plurality of terminals to a resonant circuit such that a first predetermined amount charge is transferred from the first pair of terminals to the resonant circuit, the resonant circuit including a storage element connected in series with an inductive element, causing disconnection of the first pair of terminals from the resonant circuit, electrically connecting a second, different pair of terminals of the first plurality of terminals to the resonant circuit such that a second predetermined amount of charge is transferred from the second pair of terminals to the resonant circuit, causing disconnection of the second pair of terminals from the resonant circuit, electrically connecting a third, different pair of terminals of the second plurality of terminals to the resonant circuit such that a third predetermined amount of charge is transferred from the resonant circuit to the third pair of terminals, causing disconnection of the third pair of terminals from the resonant circuit, and electrically connecting a fourth, different pair of terminals of the second plurality of terminals to the resonant circuit such that a fourth predetermined amount of charge is transferred from the resonant circuit to the fourth pair of terminals.

In another aspect, in general, a method for transferring electric charge between a power source having a first plurality of terminals and a power sink having a second plurality of terminals includes transferring charge from the first plurality of terminals to a resonant circuit including a charge storage element connected in series with an inductive element by causing different pairs of the first plurality of terminals to be electrically connected to the resonant circuit at different times, including activating a plurality of input switches disposed (i.e., positioned) between the first plurality of terminals and the resonant circuit according to a switching sequence, transferring charge from the resonant circuit to the second plurality of terminals by causing different pairs of the second plurality of terminals to be electrically connected to the resonant circuit at different times, including activating a plurality of output switches disposed between the resonant circuit and the second plurality of terminals according to a switching sequence, wherein upon completion of transferring charge from the first plurality of terminals to the resonant circuit, a first voltage exists on the charge storage element and while transferring electric charge between the first power terminal and the second power terminal, a maximum voltage applied to the plurality of input switches and the plurality of output switches is less than the first voltage.

In another general aspect, an apparatus for transferring electric charge between a power source and a power sink having a second plurality of terminals includes a first plurality of terminals connected to the power source, a second plurality of terminals connected to the power sink, a resonant circuit including a charge storage element connected in series with an inductive element, a plurality of input switches disposed between the first plurality of terminals and the resonant circuit, a plurality of output switches disposed between the resonant circuit and the second plurality of terminals, and a controller. The controller is configured to activate the plurality of input switches according to a first switching sequence such that charge is transferred from the first plurality of terminals to the resonant circuit by causing different pairs of the first plurality of terminals to be electrically connected to the resonant circuit at different times and activate the plurality of output switches according to a second switching sequence such that charge is transferred from the resonant circuit to the second plurality of terminals by causing different pairs of the second plurality of terminals to be electrically connected to the resonant circuit at different times. Upon completion of transferring charge from the first plurality of terminals to the resonant circuit, a first voltage exists on the charge storage element and while transferring electric charge between the first power terminal and the second power terminal, a maximum voltage applied to the plurality of input switches and the plurality of output switches is less than the first voltage.

Embodiments may have one or more of the following advantages.

Among other advantages, the resonant converter described below (referred to as “R-Link”) reduces the voltage requirements of the switches by 40% to 50% over conventional soft-switching (SS) converters and even more for VAR applications without losing the SS capability. The resulting configuration of the R-Link therefore increases efficiency, decreases the component voltage requirements, component count, and cost, dominated typically by the solid-state devices. This type of converter has a large number of applications in industry, defense, and in both AC and DC power transmission and distribution.

The soft switching capability also permits running the switches and therefore the converters at higher converter frequencies than is possible for conventional resonant power converters. This advantageously reduces the size of a number of passive power electronic components, specifically the magnetic components. The higher frequency capability increases the bandwidth thereby increasing the power quality of both the incoming and outgoing power flow. With reduced losses, the R-Link converter is shifted into the efficiency range that makes it economical for transmission, distribution, and industrial power flow control.

Other features and advantages of the invention are apparent from the following description, and from the claims.

### DESCRIPTION OF DRAWINGS

FIG. 1 is a prior art AC to DC converter.

FIG. 2 is a waveform produced by a prior art AC to DC converter.

FIG. 3 is an AC to DC converter with powered flow control from a low frequency AC power source to a DC port output.

FIG. 4 is an AC to DC boost mode converter with “reversal mode” and high voltage rail spike elimination.

FIG. 5 is a simplified generic circuit topology of a converter.

FIG. 6 is an effective input voltage as a function of the power factor.

FIG. 7 is an AC to DC converter including a transformer.

FIG. 8a is a bi-directional rectification section.

FIG. 8b is a bi-directional AC section.

FIG. 9 is a dual module transformer system.

FIG. 10 is a multi-port converter.

FIG. 11 is a multi-level converter power source.

FIG. 12 is a simplified VAR compensator circuit with a power transfer configuration.

FIG. 13 is a simplified VAR compensator circuit with a harmonic filtering option.

FIG. 14 is a segmented resonant circuit.

FIG. 15a is a sequencing diagram for AC-AC buck mode operation.

FIG. 15b is a sequencing diagram for AC-AC boost mode operation.

FIG. 15c is sequencing diagram for AC-AC a second buck mode operation.

FIG. 15d is a sequencing diagram for a charge and discharge sequence.

### DESCRIPTION

### 1 Overview

The present disclosure relates generally to soft switching high voltage and resonant power converter configuration with voltage limiting control on the solid-state switches (referred to as “R-Link”). This circuit topology and its control technology is applicable for high, medium, and low voltage AC and DC transmission and transformation converters changing AC to AC, AC to DC, DC to AC, DC to DC with or without voltage transformation. This converter topology and control implementation is also applicable for a large number of high power military and commercial system applications.

A previous “soft switching” resonant converter technology is described in the '678 patent, which is issued to the inventor listed on this application, and is incorporated herein by reference. The converter topology is such that it turns on and off at zero current and requires only the closing of switches and no active opening of the switches. With no current present during the turn-on and turn-off, the turn-on and turn off losses of the switches are practically eliminated. This is especially important, since for higher voltage applications it is desirable to use switches with the highest voltage rating. These switching functions are ideally obtained by thyristor type devices, since they have the lowest conduction losses and do not require to be gated off. However, any high voltage switch can be used, such as such IGBT or IGCT, as long as the device is gated off at or after the resonant current becomes zero. In the figures, a modified reverse blocking thyristor symbol is used. However, it is understood that these switches may be asymmetric non-reverse blocking devices, such as IGBT, in series with a reverse blocking diode.

Since the switching losses do not arise in the operation of the R-Link converter, high power converters can be constructed to operate with high efficiency at frequencies up to 20 kHz, using 1700V silicon IGBTs or IGCTs. This high frequency of operation permits, for the same power level, the size reduction of passive components, such as inductors and capacitors, reducing cost, system weight, and system volume.

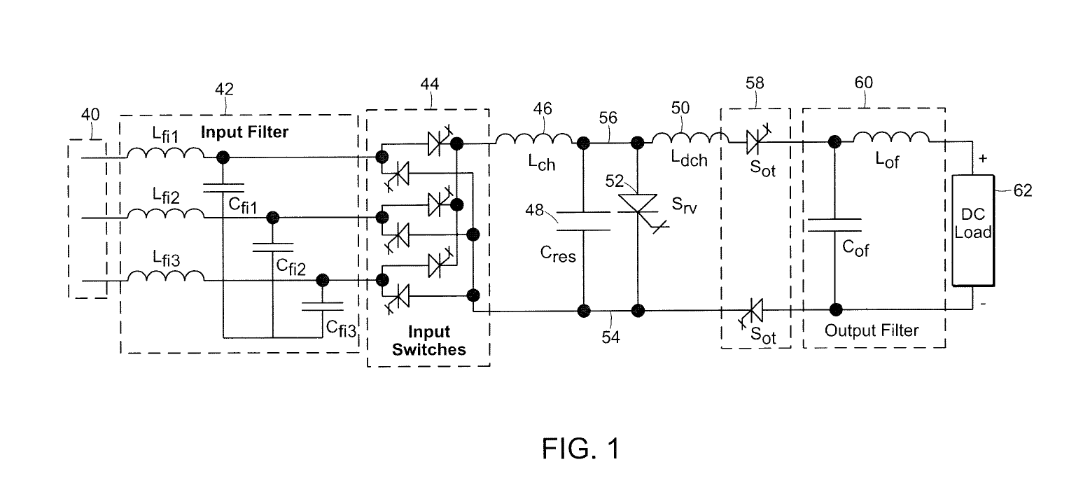

Referring to FIG. 1, an illustration of one embodiment of the prior art Soft Switching Resonant Converter (SSRC) is configured for a regulated AC to DC operation. A 50 or 60 Hz power three-phase power source is connected on the left terminals 40. A controller (not shown) cycles the input switches 44 and the output switches 58 through a switching sequence. The switching sequence causes the resonant capacitor, Cᵣₑₛ 48 to be charged through the three phase SSRC input switching section 64 and the resonant charging inductor L_{ch} 46 in a two or three step operation to about two to three times the AC RMS input voltage. As the resonant current goes to zero the input switches become back-biased and commutate off. When switches such as IGBT are used, the gate drive turns off the switches after the completion of the charging process; with this the AC input is completely isolated from the resonant L_{ch}−Cᵣₑₛ circuit. The controller then allows a time interval to elapse before activating the output switches 58 to discharge the resonant capacitor, Cᵣₑₛ 48. During the time interval, all of the input switches 44 and the output switches 58 are open. The shortcoming of this topology is that at the time the charging current goes to zero and all of the input switches 44 and the output switches 58 are open, the full Cᵣₑₛ voltage appears across both the input and the output switches. This drives the switch voltage requirement.

For the discharge operation, the output switches Sₒₚ 58 are activated to discharge the Cᵣₑₛ capacitor through the resonant discharge inductor L_{dch} 50 into the output filter capacitor C_{bf}. The C_{bf} filter capacitor and the L_{of} output filter inductor 60 provide a cut-off frequency at about 0.08 of the inverter frequency. This yields a minimum output ripple amplitude at the inverter frequency. With the SSCR system there is no 300 Hz or 360 Hz ripple for the respective input line frequency of 50 Hz or 60 Hz, since the energy per pulse (Eₚ) can be controlled on a pulse to pulse basis. Furthermore, energy and charge is drawn from every input phase, therefore yielding a low Total Harmonic Distortion (THD). The detailed operation of the converter of FIG. 1 is described by the '678 patent.

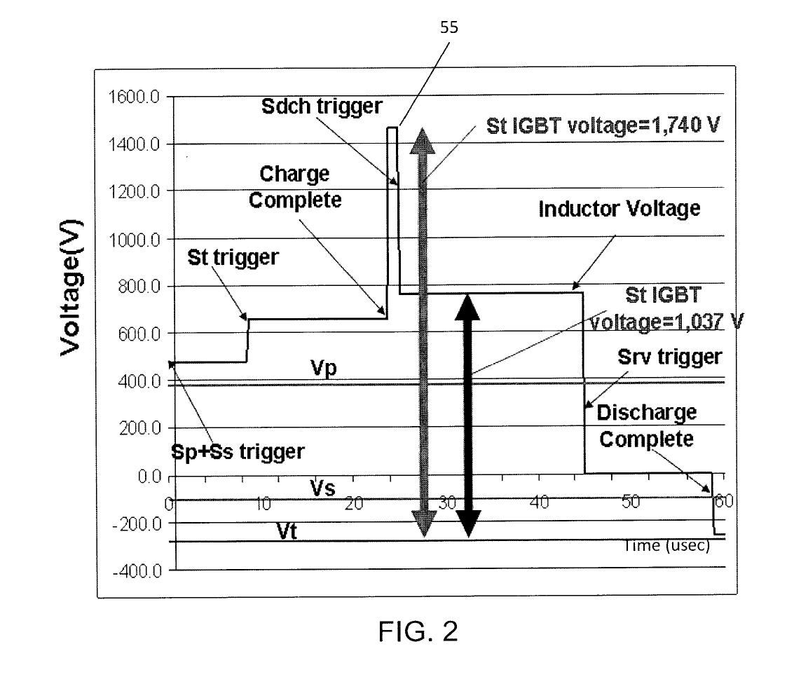

Referring to FIG. 2, the voltage profile for one SSRC cycle with a 480V AC input voltage and 1740V DC on the resonant capacitor. The “rail voltage” 55 is shown together with the instantaneous line voltage of each input phases and dictates the switch voltage requirements. The same is the case for the output switches.

The voltage on the resonant capacitor dictates the IGBT/diode reverse biased voltage requirement and that of the IGBT. This voltage is typically shared between two input or two output switches. The requirement that the switches be rated for 3.0 to 3.3 times of the AC input voltage applies to any AC voltage SSRC operation. This voltage requirement is reduced by new Resonant Link (R-Link) circuit architecture and operational control.

FIG. 2 illustrates that the rail voltage 55 (i.e, the voltage that is present on the input and output switches) reaches the full 1740V stored on the resonant capacitor, Cᵣₑₛ during the time interval between the charging and discharging phases.

2 R-Link with AC to DC Operation

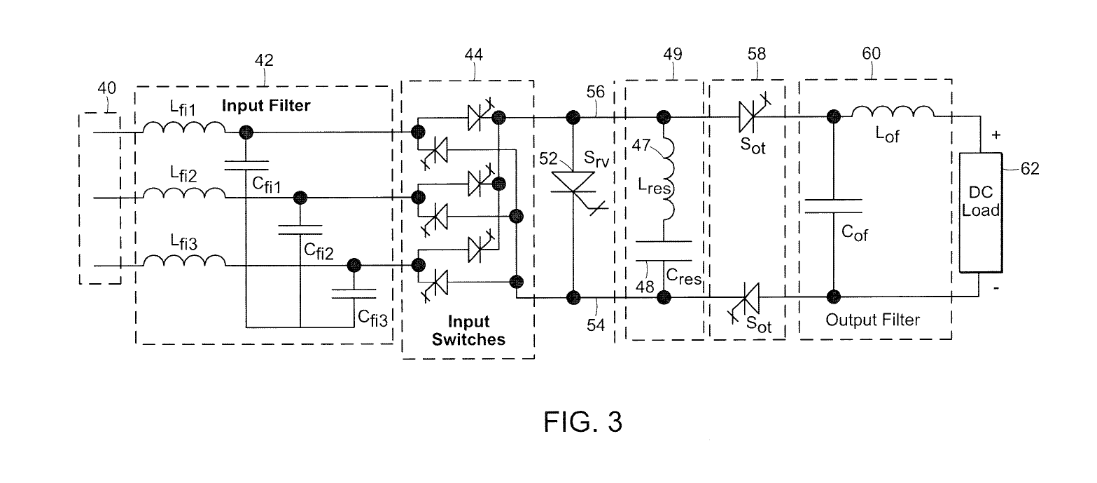

Referring to FIG. 3, another embodiment of the R-Link topology is configured for AC to DC operation and has the same AC to DC functionality as the converter circuit of FIG. 1 (i.e., the throughput power, input source condition, and the load condition are also the same). However, instead of including a charging inductor L_{ch} and a discharge inductor L_{dch}, the R-Link uses a common charging inductor Lᵣₑₛ.

A controller (not shown) controls the input and output switches of the circuit such that they follow a switching sequence that differs from the switching sequence described in the '678 patent (and summarized above). In particular, rather than leaving the input switches and the output switches open for an interval of time after charging the resonant capacitor, Cᵣₑₛ and before discharging the resonant capacitor, Cᵣₑₛ, the controller of FIG. 3 causes the input and output switches to directly and immediately transfer from charging the resonant capacitor, Cᵣₑₛ to discharging the resonant capacitor, Cᵣₑₛ.

The voltage across the series connected Lᵣₑₛ inductor plus the Cᵣₑₛ capacitor (referred the as “rail voltage”) is the same as the rail voltage for the SSRC topology during the charging and discharging process, since it is defined and clamped by the input and output voltage respectively. The maximum input voltage is V_{RMS}\sqrt{2}, or about 680 V during the charge cycle for a typical 480V AC operation.

The “rail” voltage is also clamped to the output to a lower voltage as the maximum input voltage if the converter is not operated in a boost mode. If operated in the boost mode, the output voltage is increased depending on the boost application, but will be of similar voltage requirements.

However, since the circuit of FIG. 3 uses a common Lᵣₑₛ inductor 47 in series with the Cᵣₑₛ capacitor 48, and a direct transition from the charge operation to the discharge operation, the fully charged 48 voltage (i.e., a voltage spike) never appears across the “rails” 54, 56 or “tank” circuit.

In particular, during the charging operation, current flows through the resonant inductor, Lᵣₑₛ, and the resonant capacitor, Cᵣₑₛ, causing the charge on Cᵣₑₛ to increase. As the charge on Cᵣₑₛ increases, the amount of current flowing through Lᵣₑₛ and Cᵣₑₛ decreases. The resonant inductor, Lᵣₑₛ opposes this change in current (i.e., dI/dt) by dropping the voltage necessary to oppose the change. During the charging operation, the voltage applied to the rails is equal to the voltage drop over Lᵣₑₛ plus the voltage drop over Cᵣₑₛ. Since the voltage drop over Lᵣₑₛ is opposite in polarity to the voltage drop over Cᵣₑₛ, the total voltage applied to the rails is less than the voltage drop over Cᵣₑₛ. Thus, during the charging operation, the maximum voltage applied to the rails is always less than the maximum voltage of the resonant capacitor, Cᵣₑₛ.

When the controller transfers the circuit from the charge operation to the discharge operation, the voltage on the resonant capacitor, Cᵣₑₛ causes current to flow through the resonant inductor, Lᵣₑₛ to the output switches. The sum of the voltage on the inductor Lᵣₑₛ and the capacitor Cᵣₑₛ is matched to the rail voltage during both the charging and discharging operations. The matching of the sum of the voltage on the inductor Lᵣₑₛ and the capacitor Cᵣₑₛ causes in a rate of change in the current (i.e., dI/dt). The voltage on the inductor Lᵣₑₛ is given by Lᵣₑₛ dI/dt where the instantaneous dI/dt is given by (Vᵣₐᵢₗ−V_{cres})/Lᵣₑₛ. If (Vᵣₐᵢₗ−Vᵣₑₛ) is larger than zero, the resonant current increases while if (Vᵣₐᵢₗ−Cᵣₑₛ) is less than zero the resonant current decreases. In this way, having the resonant inductor Lᵣₑₛ in series with the resonant capacitor Cᵣₑₛ buffers the Cᵣₑₛ voltage from the rail voltage. The buffered Cᵣₑₛ voltage is the voltage that is seen at the input and output switches.

Thus, the combined effect of including the series resonant inductor, Lᵣₑₛ and immediately switching between the charging operation and the discharging operation reduces the maximum voltage applied to the switches.

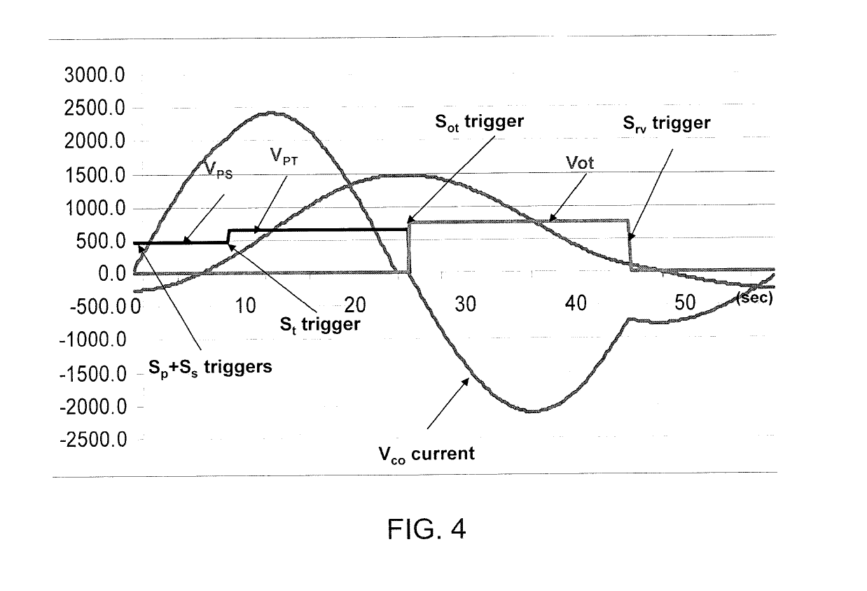

FIG. 4 shows the result of the voltage spike elimination with the R-link circuit topology of FIG. 3 and control system with the modified switching sequence. The voltage spike, shown between charging and discharging in FIG. 2 is eliminated by triggering the discharge immediately after the completion of the charge cycle. Doing so reduces the switch voltage requirement by over 1000 V as seen by the rest of the none-conducting switches. The voltage reduction is of the order 40% to 45% with this direct transition and is applicable for any R-Link configuration (i.e., AC to AC, AC to DC, DC to AC, DC to DC with both direct input to output connection).

This voltage reduction of the solid-state components is also applicable for the four operations listed above if circuit and circuit control is integrated with a high frequency transformer to permit voltage step-up or voltage step-down, as is described in more detail below.

### 3 R-Link Operational Detail

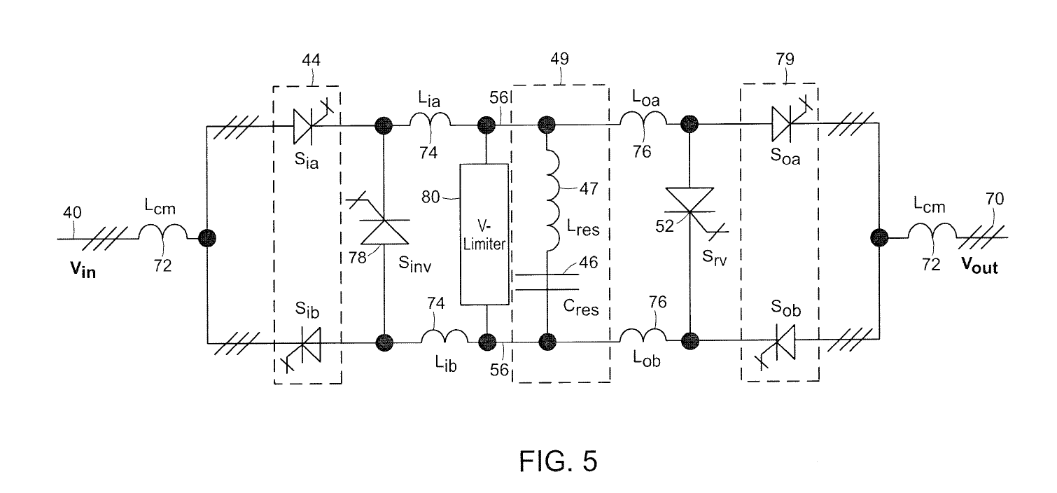

Referring to FIG. 5, a simplified generic R-Link circuit topology is presented. The input and output filtering sections are not shown for clarity. The circuit is symmetrical in that power flow can occur from right to left and left to right with the input voltage 40 either lower or higher than the output put voltage 70. The input or output terminals are either two-wire DC or three-wire AC. The circuit can also operate with a higher number of phases, for example, an eight phase permanent motor or generator or three phase with a neutral connection. Further terminals are optional on either side for energy storage, harmonic mitigation, and other functions.

The resonant section 49 includes the resonant capacitor, Cᵣₑₛ 48, the resonant inductor, Lᵣₑₛ 47, an additional inductance 74 added on the input, and another additional inductance 76 added on the output. The additional inductors can be smaller or larger than the primary resonant inductor Lᵣₑₛ. In some examples, the inductors are selected to provide a fine tuning of the discharge time with the respect to the charging time. With the addition of the inductors, the voltage on the switches increases. Therefore, the inductance values of the additional inductors are typically minimized. One of the additional functions of the inductors is to provide inductive isolation between the input and output terminals during the charge and discharge commutation period. This is specifically important if in a power system with both the input and the output power system hard wired to ground. The inductive isolations relax the requirements for trigger timing accuracy.

An optional voltage limiting element (V-Limiter) 80 is connected between the “rails” 54 and 56 to limit a fast voltage rise in the time between the input switches turning off and the output switches closing. With accurate timing, this limiter is not needed or only used as backup. The voltage limiter is designed to limit a number of charge/discharge operations with faulty timing. The voltage limiter may include a snubber circuit, a metal oxide varistor (MOV), other voltage limiting device(s), a clamp to a voltage sink, or an active clamping circuit. The voltage limiter also acts as a safety device should the triggering system fail or the operation is stopped, as a result of a number of potential failures.

Added in series with both the input and output are commutation inductors L_{cm} 72. These are small, typically air core inductors that are made up by the cable interconnection with two or three loops of the cable. Alternatively small single-turn split-core inductors could be used. With these inductors, the commutation time can be slowed and the slope of the current, dI/dt, can be controlled during commutation of the switches.

The inversion switch Sᵢₙᵥ 78 is used if the effective input voltage is larger than the output voltage for buck mode operation. This switch is optional if we used a multi-phase input, since the input switches, such as those shown in FIG. 3, can be used to perform the “inversion” functionality. If the effective output voltage is larger than the effective input voltage the “reversal” switch Sᵣᵥ 76 is required. This permits the boosting of the output voltage over that of the input. The output switch configuration 79 is the mirror image of the input switch configuration 44. For three-phase AC, with no neutral, a total of six switches are required for each the input and output sections, as shown FIG. 3.

While the symmetrical circuit shown in FIG. 5 is configured for AC to AC operation, the same architecture can be used for DC operation on either side or on both sides. For DC operation, the required switches are simply reduced.

For steady state operation, with many R-Link operations per AC input or AC output cycle, the following conservation requirement exists.

With no net energy stored in the Cᵣₑₛ 46 capacitor the input energy per pulse has to be identical to the output energy given by the following equation (conservation of energy).

Qᵢₙᵥ*Vᵢₙᵥ+Qᵢₛ*Vᵢₚₛ+Qᵢₙₜ*Vₚₜ=Qᵣᵥ*Vᵣᵥ+Qₒₛ*Vₒₚₛ+Qₒₜ*Vₒₚₜ (1)

Since the voltages Vᵢₙᵥ and Vᵣᵥ are defined by the circuit as zero, equation 1 simplifies to:

Qᵢₛ*Vᵢₚₛ+Qᵢₙₜ*Vₚₜ=Qₒₛ*Vₒₚₛ+Qₒₜ*Vₒₚₜ (1a)

For AC to DC operation equation 1a reduces to:

Qᵢₛ*Vᵢₚₛ+Qᵢₙₜ*Vₚₜ=Qₒᵤₜ*Vₒᵤₜ (1b)

Each of the terms in equation (1b) defines the energy per pulse drawn and transferred per operation. The first term is the charge energy drawn between the primary and secondary AC input terminal, the second term is the energy drawn from the primary and tertiary terminals, while the term on the left side of the equation is the energy delivered to the output terminals. The inversion term drops out since no energy is drawn during the inversion process, since the inversion source voltage is zero. It is also zero, if the reversal operation is used. For special operation none-zero inversion or reversal voltage may be used. This has a number of applications for system energy storage, harmonic compensation, or system control power generation.

The conservation of charge requires the following equation:

QᵢₙᵥQᵢₛ+Qᵢₜ=Qᵣᵥ+Qₒₛ+Qₒₜ (2)

For an output voltage lower than the input voltage the reversal charge transfer Q, is set to zero. This yields, for the illustrated AC to DC operation, the following conservation of charge equation:

QᵢₙᵥQᵢₛ+Qᵢₜ=Qₒₜ (2a)

For a voltage boost mode operation the Qinv equation (2) is set to zero and yields for the illustrated AC to DC operation the following equation:

Qᵢₛ+Qᵢₜ=Qₒₜ+Qᵣᵥ (2b)

Equation 2a and 2b are arranged from left to right in the same sequence as the control system has to address the switch triggering requirement in order not to cause a “hard switched” event.

For AC operation, we define the following phase as the primary (p), secondary (s), and tertiary (t) voltage, when operating with unity or closed to unity input power factor, we define “p” by |Iₚ|>|Iₛ| and |Iₛ|>|Iₜ|. The “s” and “t” are defined for the input |Vₚ−Vₛ|<|Vₚ−Vₜ| and for the output |Vₚ−Vₛ|>|Vₚ−Vₜ|.

For a balance system we also have:

Vᵢₚ=−(Vᵢₛ+Vᵢₜ) (3)

For the system's buck mode operation, we start with the “inversion” mode. For that we can use the Sₚₚ and Sₚₙ switches. This is equivalent of using one inversion switch. Next we apply the primary-secondary input voltage Vᵢₚₛ by turning on the secondary switch, this back-biases and turns off the complementary primary switch. This conduction is permitted to run until sufficient secondary charge is drawn. Finally we apply the primary-tertiary voltage Vᵢₚₜ by triggering the tertiary switch. This back-biases the secondary switch and turns it off. The resonant charging operation goes to completion with the current going to zero. With no current flowing and if thyristors are used these thyristors commutate off; and if opening switches are used, we can now safely turn-off the opening switches without incurring switching losses. A number of opening power switches are available and IGBTs or IGCTs can be used. However, any other switch may be used. Since the switches are not opened under current, such as in a hard switched PWM system, the operation is “soft switching” and the hard switched losses of a PWM operation are eliminated.

To limit the voltage on the rails, the system goes directly from charging to discharging operation. As the charge current becomes zero, the primary-secondary output switches are triggered. As the predetermined secondary charge has been transferred, the tertiary output switch is triggered. That back-biases the secondary output switch and turns it off. At this point the discharging continues through the primary and tertiary output switches. As the current becomes zero the switches open or are opened and the voltage on the rail voltage becomes that of the residual voltage.

The rule for the soft switching R-Link operation is that for the charging process the applied input goes from low to high, with the inversion starting out at zero volts. For the discharge operation the highest output voltage terminal is connected, with commutation taking place by connecting a lower voltage output. Since the reversal voltage is zero, it is typically the last operation. For more sophisticated control and system architecture, soft switching commutation can also be achieved with an initial negative input voltage or a negative output voltage.

### 4 Effective Input Voltage

For the AC operation of the R-Line topology, the effective voltage V_{eff} term, as defined below, is used.

The effective AC input voltage for the resonant circuit is not the RMS voltage but is given by the equivalent value that charges the Cₒ capacitor to the same level as from a DC input voltage source. The final DC voltage V_{cof} is given by:

V_{cof}=2*Vᵢₙ−Vᵣₑₛ (4)

as a function of the input voltage Vᵢₙ and the Vᵣₑₛ, the residual capacitor voltage. For the R-Link with an AC input the input voltage Vin of equation (4) is replaced by the V_{eff} voltage given in Equation 5.

The three phase currents and voltages are given;

V₁=Vₒ*sin(ωt) I₁=Iₒ*sin(ωt−φ)

V₂=Vₒ*sin(ωt−120) I₂=Iₒ*sin(ωt−φ−120)

Vₛ=Vₒ*sin(ωt+120) I₃=Iₒ*sin(ωt−+120)

For the R-Link with an AC input the input voltage Vᵢₙ of equation (4) is replaced by the V_{eff} voltage given in Equation 5:

V_{eff}=Abs[(Iₛ*(Vₚ−Vₛ)/Iₚ+Iₜ*(Vₚ−Vₜ))/Iₚ] (5)

The current amplitude Iₒ drops out and it follows that the effective input voltage is not a function of the power. With the voltage and current phase shift φ, V_{eff} can be calculated at any point in time for 0>ωt>2π of the AC input or AC output system. For DC it is simply the DC voltage.

The definition of the “p” primary “s” secondary and “t” tersely has been defined previously. R-Link trigger requirement is for “p and s” to conduct first followed by “p and t”.

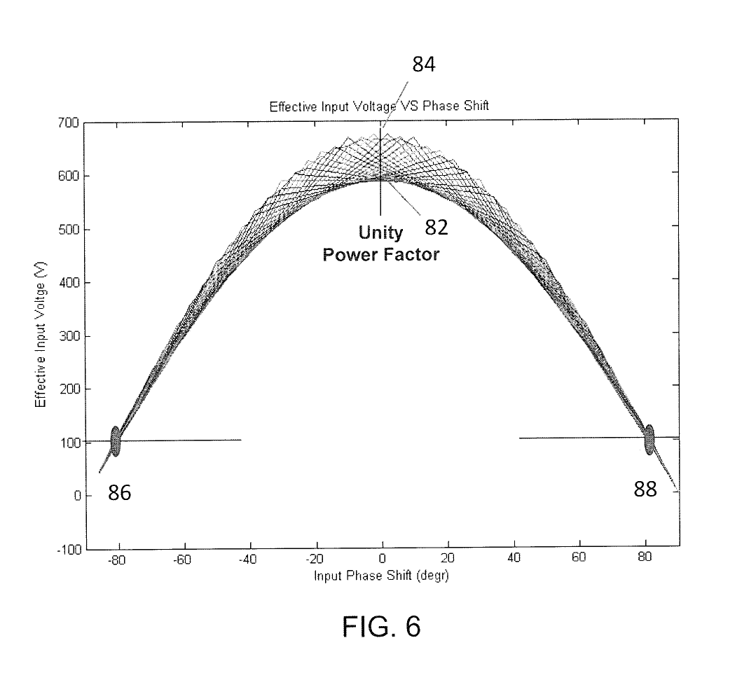

Referring to FIG. 6, the effective voltage in increments of 10 electrical degrees for a 480V AC line voltage is shown. At the unity power factor, the effective voltage is between 588V 82 and 679V 84. The general range at unity power factor is;

\sqrt{2}Vrms<Veff<\sqrt{3/2}Vrms (6)

Equation (4), yields a different central capacitor voltage for every electrical degree. However, the control system is set up such that the residual voltage yields the Cᵣₑₛ charge to transfer the energy per pulse. This mode of operation is implemented for both the “buck mode” (effective input voltage higher that the output voltage using the inversion operation) and the “boost mode” with the output voltage higher than the effective input voltage.

FIG. 6 also shows that the effective input voltage can be lowered by drawing real and reactive power. This is referred to as the “VAR control” mode. With a phase shift of about 80 electrical degrees leading 86 or lagging 88, the effective input voltage is reduced to about 100V. This draws a large amount of reactive current but only a small real amount of power. However, we can draw no net reactive current by alternating the charging by drawing a leading current reactive component following by a second pulse with a lagging reactive current component. Since the reactive components cancel, only the two real current components are drawn or injected into the AC terminals.

Operating at either at 90 electrical degrees leading or at 90 electrical degrees lagging, the system operates as a VAR compensator. For that mode of operation the central capacitor voltage reverses the polarity on every pulse. This does not draw any real power off the grid, however a practical system operates slightly off the −90 or +90 degree point, since a small real energy components is needed to make up for the switch and passive component losses.

### 5 R-Link Control Illustration

Having defined the effective three-phase voltages, for both input and output, the control requirements can be established for an AC to DC operation. We start out with the buck mode operation with the output voltage lower than the input voltage. With the power requirement and the selected converter frequency the steady state input and output energy per pulse is given. We also assume that we are regulating to obtain a steady state DC output voltage of Vₒₜ for the AC to DC circuit of FIG. 3.

Eₚ=Eᵢₙ=Eₒₜ=QₒₜVₒₜ=QᵢₙV_{eff} (7)

This defines the input and output charge transfer requirements in terms of known parameters. Depending on the input and output voltage amplitude, we may operate the system in the Buck Mode, if the output is lower than the input voltage, or in the boost mode if the output voltage requirement is higher than the input voltage.

### 5.1 Buck Mode Operation

To implement buck mode, the required final charge voltage on the Cᵣₑₛ capacitor, V_{cof} (the voltage requirements that yields the required output energy transfer) is computed using the output resonant equation, assuming no or minimum circuit losses:

V_{cof}=2*V_{eff}−Vᵣ (8)

Using charge conservation of:

Qᵢₙᵥ=Qᵢₙ−Qₒₜ (9)

manipulating equations 7, 8, and 9 and using Qₓ=Cᵣₑₛ(V_{y}−V_{z}) we compute the required final capacitor charge voltage:

V_{cof}=V_{eff}+Eₚ/(2V_{eff}Cᵣₑₛ) (10)

And the residual voltage is computed as:

Vᵣ=V_{eff}−Eₚ/(2V_{eff}Cᵣₑₛ) (11)

Using energy conservation we can modify equation 9 to yield,

Qᵢₙᵥ=Eₚ(1/V_{eff}−1/Vₒₜ)=Cᵣₑₛ(Vᵣ−Vᵢₜ) (9a)

For correctly controlled R-Link system, the residual voltage Vᵣ is negative.

The charging process starts by shorting the series Lᵣₑₛ−Cᵣₑₛ components through an inversion switch. For an AC input, two primary switches of the same phase are used. For a DC input, an inversion switch needs to be added. At the time “tᵢₜ” stop the inversion and trigger the secondary switch with the central capacitor at the Vᵢₜ voltage. From equation 9a the Vᵢₜ voltage is given by:

Vᵢₜ=Vᵣ−(Eₚ/Cᵣₑₛ)(1/V_{eff}−1/Vₒₜ) (12)

From a control system convenience it may be more beneficial to know the time for the secondary switch trigger. From L-C circuit topology the inversion voltage as a function of time can be simply obtained. This yields the time tit for triggering the secondary switch:

Vᵢₜ=Vᵣ cos(ωLCtᵢₜ) ωLC=ω₀=1/\sqrt{LresCres} (13)

The applicable solution to equation 13 is in the range of 0<ωₜtᵢₜ<π.

With a DC input the charging is allowed to go to completion yielding a V_{co} of V_{cof}. With an AC input the tertiary switch is triggered at V_{if} given by known parameters as;

Vₜ=Vᵢₜ−Eₚ|(Iₛ/Iₚ)| (14)

The triggering time for the tertiary switch may be similarly computed as for equation 13, starting out with the initial voltage and current Vᵢₜ, Iᵢₜ. All of this information can be pre-calculated for every electrical degree and power level. The stored lookup table values can be pulled out and actively refined for every power and line voltage condition.

In summary the triggering for the buck mode operation has three input triggering events and one discharge triggering event. The inversion is triggered at the time zero and is topped by triggering the secondary switch at Vᵢₜ or tᵢₜ. This time of the inversion defines the energy per pulse. The secondary current duration is terminated with the triggering of the tertiary switch. This point is defined by the desired input current phase angle. Finally as the charge current goes to zero, the discharge switch is triggered. This limits the rail voltage and the rail voltage transitions from the primary tertiary voltage to the output voltage; eliminating that the Cᵣₑₛ voltage and associated voltage spike across the rails and all input and output switches.

### 5.2 Boost Mode Operation

For the voltage boost mode operation the reversal switch Sᵣᵥ 52, shown in FIG. 5, is activated, since the output charge is less than the input charge. This switch needs to be added to the circuit topology of FIG. 3 and connects between the upper and lower rail. The following equation applies for this AC to DC boost mode operation:

Qᵢₙ=(Qᵢₛ+Qᵢₜ)=Qₒₜ+Qᵣᵥ (14)

QᵢₙV_{eff}=(QᵢₛVₚₛ+QᵢₜVₚₜ)=QₒₜVₒₜ (14a)

The input energy and charge used to yield:

Qᵢₙ=Eₚ/V_{eff}=Cᵣₑₛ(V_{cof}−Vᵣ) (15)

The resonant charging equation is given by:

V_{cof}=2*V_{eff}−Vᵣ (16)

Equation 15 yields both the reversal voltage and the final charge voltage:

V_{cof}=V_{eff}−Eₚ/(2Cᵣₑₛ) and Vᵣ=V_{eff}+Eₚ/(2Cᵣₑₛ) (16)

For the boost mode charging the primary and secondary switches are triggered. As the central capacitor voltage reaches Vₜₜ the tertiary switch is triggered. This voltage is given as:

Vₜₜ=Vᵣ+(Eₚ/Cᵣₑₛ)(Iₛ/Iₚ) (17)

We can similarly work out the time tₜₜ the tertiary switch is triggered.

The charging process comes to a conclusion once the current goes to zero. At that point the input switches become back-biased and with any additional action the full V_{cof} voltage appears across the positive 56 and negative 54 rail. This is the point in the process the input switches are back biased and the output switches are forward biased to avoid unnecessarily high voltage. To prevent this we immediately transfer from the charge to the discharge mode by triggering the discharge switches 56. This clamps the rail voltage to the output voltage and actively controls the rail voltage as seen in FIG. 4. It also eliminates the high voltage spike shown in FIG. 2 to less than two times the RMS voltage. This reduction permits the voltage requirement of not only the switches and some of the passive component, but also increases efficiency.

With no further action the discharge would come to a conclusion and the residual voltage would be too low for a proper next charging cycle. This is where the reversal switch 52 comes in since the trigger of the reversal switch controls the energy per pulse, Ep. As shown in FIG. 4, the discharge starts by triggering the output switches at the conclusion of the charging process. The Cᵣₑₛ voltage starts with V_{cof} and is allowed to discharge to a voltage Vᵣᵥₜ, where the reversal switch is triggered, reduces the rail voltage to zero, and stops energy to flow into the output. V, is computed from the output energy requirements and charge conservation of equation 18:

Eₚ=QₒₜVₒₜ=Cₒ(V_{cof}−Vᵣᵥₜ)Vₒₜ, Vᵣᵥₜ=V_{cof}−Eₚ/(Cₒ−Vₒₜ) (18)

During the reversal process the energy remaining in the Cᵣₑₛ 48 capacitor and Lᵣₑₛ 49 inductor results in a negative Vᵣ voltage of equation 16.

We can again use the time dependent V_{co}(t) voltage for the discharge from V_{cof} to Vᵣᵥₜ to obtain a triggering time requirement. Once the reversal is over, the reversal switch recovers, and the rail voltage sees the negative residual voltage Vᵣ. This is, for most applications, much lower than the Vₚₜ or Vₒₜ voltages. However, for high boost mode operation with a high reversal voltage, the selected switch voltage requirement would be determined by the residual voltage.

The above illustrations for both the buck and boost mode operations assume no losses and no commutation inductors. To limit the dI/dt during the commutation process, small commutation inductors 72 are use as shown in FIG. 5. This requires the triggering of the switches earlier by half the commutation time. This again can be calculated and the timing can be adjusted. With a high speed microprocessor, the computation can be performed in real time or pre-calculated and stored in lookup tables. These lookup tables can be dynamically updated to adjust for line voltage fluctuation, load, harmonic voltage distortion, line frequency changes, and other grid variations. Corrections are typically made and implemented 120 electrical degrees later in an AC system. Also for accurate operation, the actively updated lookup tables factor in small passive component changes due to heat and other factors. Furthermore, for a high speed converter, the effect of a previous pulse inaccurate timing can be effectively corrected on the next or subsequent pulses.

6 R-Link Operation with Transformation

The R-link buck or boost mode operation permits the system to operate with a voltage step down or step-up. However, a large voltage change has practical limitations. In the '678 patent, we replaced either the charging or discharging inductor with the leakage inductor of a transformer, permitting the transformer to operate at the inverter frequency. This approach allowed for a core area reduction by a factor of two hundred using an inverter frequency of 20 kHz in comparison with a 60 Hz transformer. With the transformer core reduction, the copper weight is also significantly reduced, yielding a device with a total weight of 26 lbs for a 250 kW system. To minimize the core losses for high frequency operation, advanced core material, such as nanocrystalline table wound core material, is desirable for both the transformer and inductor cores.

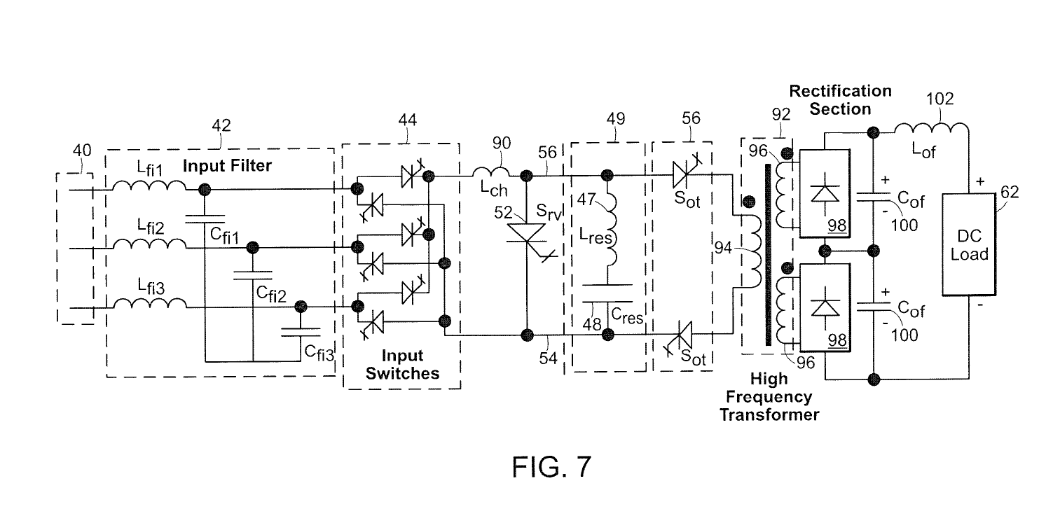

A similar approach can be implemented with the R-Link operation. However, unlike in the '678 patent, where transformer leakage inductance is equal to the discharge inductance requirements, the R-Link transformer is designed with a lower leakage inductance, such that the dominant discharge resonant inductance reside with the common Lᵣₑₛ inductor. A modified AC to DC configuration is shown in FIG. 7. In particular, the discharge inductance is a common Lᵣₑₛ 47 plus the leakage inductance of the transformer, while the charge inductance is the common Lᵣₑₛ inductor plus an additional small inductance, L_{ch}. Once the transformer leakage inductance Lₓₗ is defined, the Lᵣₑₛ inductance is selected to yield the desired discharge period. With the common inductor defined, the additional L_{ch} 90 inductance can be selected to define the desired charging period. It is obvious, that we would like to operate with low L_{ch}/Lᵣₑₛ ratio to minimize the voltage of the upper 58 and lower 56 rails.

The transformer 92 shown in FIG. 7 has a primary winding 94 plus a number of secondary windings 96. Two isolated secondary windings are shown for illustration purposes, with each secondary winding connected to a passive rectification section 98 and the DC output is connected to filter capacitors 100. For this illustration the filter capacitors are connected in series. The winding voltage is selected to match the voltage requirements of the diodes such that no series connected diodes and diode voltage grating is required. Any number of secondary windings may be used such that we can obtain a high AC to DC voltage power supply without having to go through a standard. DC stage. To reduce the ripple from the converter, an output filter inductor L_{of} 102 is also shown.

The same approach can be used for a low DC voltage high current power supply. It would be designed to the diode (current) requirement. In this case a number of windings may be used in parallel to yield the total output current requirements.

FIG. 7 shows a DC output with a passive diode with a voltage transformation between the primary and secondary. We can also use the secondary winding to a three-phase AC reconstruction section and produce a three phase output with transformed voltage. Since we have the option of selecting the transformer's turns-ratio we can set up the system in either the buck and boost mode operation. Therefore this architecture can yield an AC to AC or DC to AC transformer. For the buck mode, the AC output section would have a two mode operation with primary-secondary followed with a primary-tertiary discharge. Both the primary and secondary output switches would be synchronized. With the buck mode the Sᵣᵥ switch does not have to be installed. Obviously for some modes of operation the reversal switch is installed to operate both in the buck and boost mode operation. One such example would be the AC power control from wind turbines or ocean turbine power source, with a highly varying AC input voltage, feeding the DC power output into a common DC power transmission line.

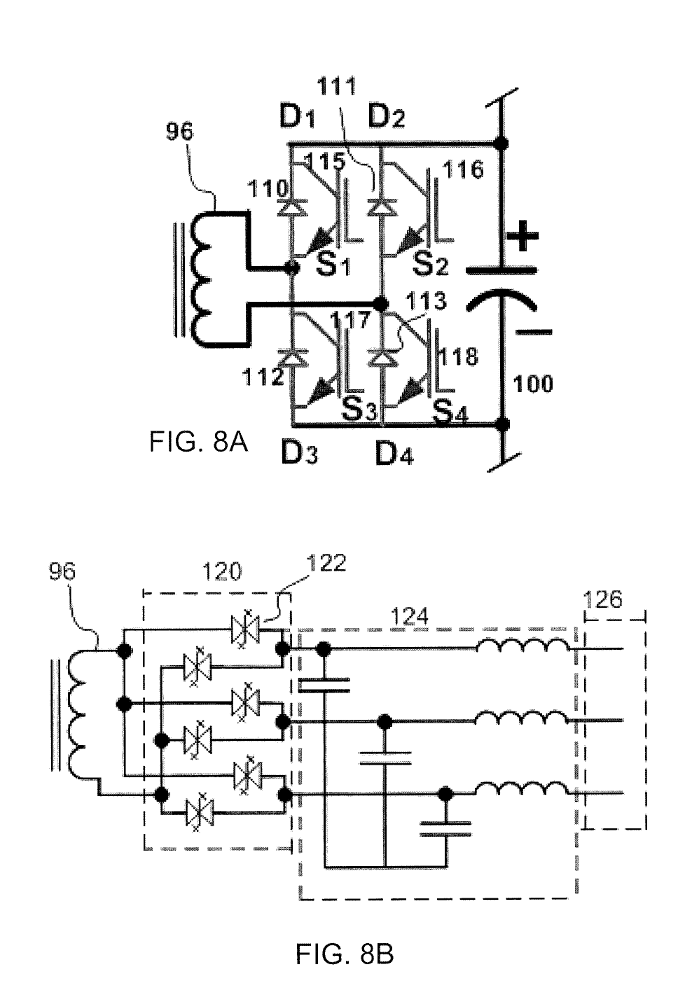

The circuit shown in FIG. 7 has a passive rectification circuit. However, an active rectification circuit could be used as well. One form of output rectification is shown in FIG. 8 using commercial IGBT modules with anti-parallel diodes. In this configuration the AC-Xtr-DC (where Xtr refers to a Transformation) operation can be made bidirectional. For a positive secondary winding 94 output pulse, the diodes D1 110 and D4 113 connect the secondary transformer winding to the filter capacitor 100. As the current goes to zero, a negative output voltage appears on the transformer winding as a result of the transformer magnification inductance. This voltage is clamped to the output filter capacitors through the diodes D2 111 and D3 112, recovering the magnification current energy and resetting the transformer core. However more importantly, the voltage of the secondary transformer winding 94 is clamped to the filter capacitor 100 voltage. This clamping effect is also limited by the voltage on the primary winding.

The circuit in FIG. 8 also permits changes in the direction of the power flow from the DC filter capacitor 100 voltage through the IGBTs S₂ 116 and S₃ 117, connecting to the transformer winding 96 for a DC-Xtr-AC operation. The negative polarity output of the primary winding 94 is connected across that resonant inductor Lᵣₑₛ 47 and charging the capacitor, Cᵣₑₛ 48 to a negative voltage. In this power flow direction, as soon as the charge current from the left DC source goes to zero, the primary and secondary switches are connected to limit the voltage across the rails of 54 and 56. This is followed by the triggering of the tertiary switch. In this way, with the proper timing, the three phase output can be reconstructed with the proper frequency and phase. If boosting is needed, the discharge is clamped by triggering the second primary switch, shorting the rails, and increasing the positive Cᵣₑₛ residual voltage. This makes the AC reconstruction a three step operation.

For the DC-Xtr-AC buck mode operation, the DC charging process is started with the Sᵣᵥ 52 triggering to inverter the positive residual voltage in the Cᵣₑₛ capacitor. This makes the DC charge a two-step operation. This process follows the same mathematics as for AC-DC buck mode operation described previously. Once the Cᵣₑₛ residual voltage is sufficiently inverted both the Sₒₜ 60 and the S₂ and S₃ IGBT switches in FIG. 8 are triggered, back-biasing the Sᵣᵥ switch, starting the Cᵣₑₛ charging process. As soon as the charging current goes to zero the two step AC reconstruction mode is initiated. This Sᵣᵥ switch is used as the reversal switch for the AC-Xtr-DC boost mode and the DC-Xtr-AC buck mode inversion.

This bidirectional mode works for the R-Link system for AC-AC, AC-DC, DC-DC, and DC-AC operation. For all operations, the rail voltage is limited with an immediate charge to discharge transition. There are a number of detailed circuit implementations. One key feature is the control or limitation of the inductive kick, as the forward voltage switch recovers, needs to be addressed with the use of a transformer. As described above for the AC-Xtr-DC operation the diode configuration of FIG. 8a performs this function. Other passive or active means can be used. A number of active approaches are specifically described in U.S. Pat. No. 8,000,118.

FIG. 8a shows the bi-directional AC switching section 120, connected to the transformer secondary 96 used for bi-directional AC-Xtr-AC or DC-Xtr-AC operation. This AC-port is the mirror image of the AC input switching section of 44, however configured with bi-directional AC switches 122. One of the ways of configuring such AC switches is by connecting two IGBT with anti-parallel diodes back-to-back. To reduce the ripple on the AC terminal 126, a simple AC output filter is used. This filter is again also a mirror image of the low-pass AC input filter 42 and is practically identical in component arrangement. Obviously a number of other filter configurations can be used to optimize specific performance requirements, cost, and other engineering considerations. These filters may be constructed with either passive components or are active filters.

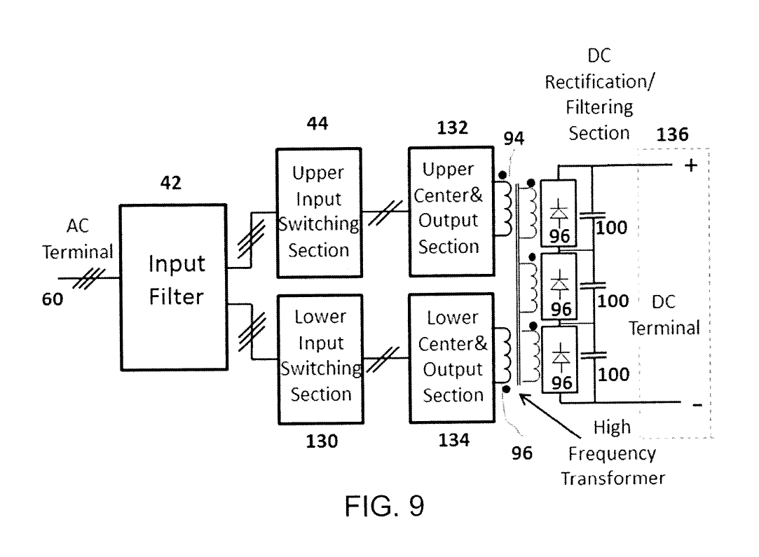

To reduce the core cross section of the transformer and the output filtering requirement, two input modules, as shown in FIG. 9, can be operated in a push-pull operation. The two modules shown in FIG. 7 may be run in parallel, sharing AC input filtering section 42. As the “upper” module charges through the upper switching section 44, the “lower” module discharges through the output switches in the “lower” “Central & Output Section” 134. FIG. 9 shows a second primary transformer winding 95 with a polarity opposite the polarity of the first primary winding 94. The output from the lower output section 134 therefore reverses the magnetic flux in the core and produces an inverter current waveform from that of the upper output section 134. The second step in the operation is that the roles of the upper and lower sections are reversed and the transformer output receives an inverted output pulse. With the illustrated DC output 136 of FIG. 9 three secondary windings are shown, rectified by the rectification modules 98. The rectified voltages of the output filter capacitors 100 are connected in series to generate the DC output voltage 136. The discharging of the C_{rec} 46 is immediately followed by its charging to limit the rail voltage on the corresponding terminals 54 and 56. A short pause may be inserted between the discharge and corresponding recharge as the residual voltage of the C_{rec} capacitor is low.

The push pull operation of the circuit of FIG. 9 can be reconfigured on the output as DC step-down where the output has a plurality of parallel output windings, multiple isolated DC output sources, a plurality of AC output sources, or a mixture of AC and DC output sources.

The dual module AC input can be also reconfigured for a dual module push-pull DC input. Furthermore, with the architecture and switching configuration introduced previously the operation can be configured for bi-directional operation.

### 7 Multiport Configuration

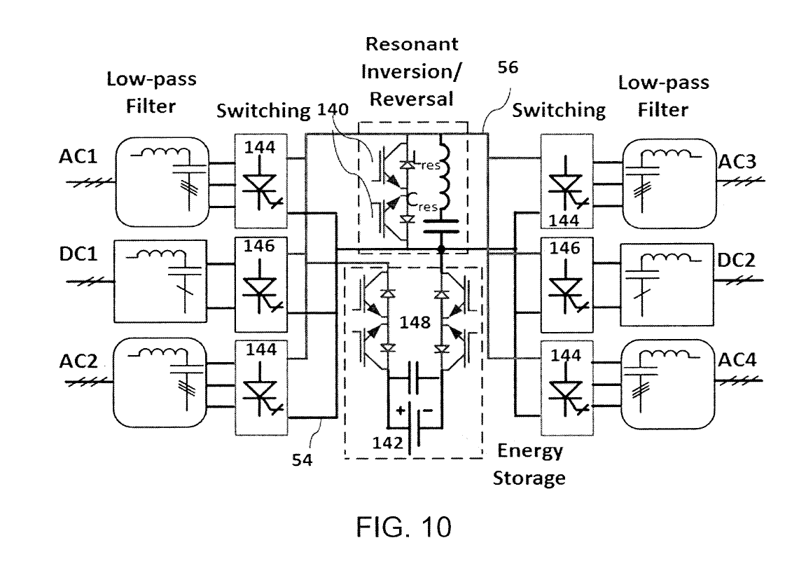

The R-Link topology is such that the energy per pulse is transferred into the temporary energy storage device of Cᵣₑₛ. After that transfer the system does not know where the energy came from. Energy in the capacitor can be transferred out to a number of AC or DC power terminals connected to the series Lᵣₑₛ−Cᵣₑₛ circuit. With this configuration, power can be transferred from any power terminal to any other power terminal, be it AC or DC with or with voltage step-down or step-up. FIG. 10 is a typical illustration of such a circuit. It specifically illustrates the R-Link configuration with energy storage.

To permit bi-directional and fully controllable, the “AC switch” is configured with two standard IGBTs 140 with anti-parallel diodes connected in parallel with the resonant Lᵣₑₛ−Cᵣₑₛ circuit. These switches function as inversion and reversal switches as described above. This permits the system to operate in both buck and boost mode for any two of the power terminal power flows. This resonant circuit is connected to the lower Lᵣₑₛ−Cᵣₑₛ and upper R-Link rails 56. These two rail terminals are connected in parallel to all of the AC 144 and DC 146 switching sections. Also added to FIG. 10 is an energy storage system such as a battery 142. Two “AC switches” make up the DC switching section 148, connecting the rail terminals to the battery bank resonant circuit. This switching section is bi-directional and provides full pseudo galvanic operation, since both terminals are switched. For a floating battery bank or a capacitor energy storage system, one of the “AC switches” can be eliminated. Other energy storage system may be connected to either a DC power terminal or the AC terminal, powering flywheels.

Each AC power terminal may operate at a different frequency, phase, or voltage. With voltage difference of about 50%, direct power connections, as shown in FIG. 3, may be used. For larger voltage step-up or step-down transformation any of the AC or DC terminals may be modified with a high frequency transformation approach similar to that introduced in FIG. 7 for either AC or DC power terminal connection.

This architecture may be used as a power router. Power may be redirected almost instantaneously from one R-Link cycle to the next, in a fraction of an AC power cycle. The transfer speed is obviously somewhat slower, and is completely determined by the low-pass input or output filter shown in FIG. 10. However, with the R-Link operating at 10 kHz, and a transfer time of approximately 5 R-Link cycles, a transfer period is on the order of 0.5 msec.

This system may draw power from either one or two input power sources in an alternating fashion. If one power source is overloaded, the power ratio can be seamlessly changed or instantaneously transferred from one power source to the next.

### 8 Multiple Galvanic-Isolated DC Power Sources

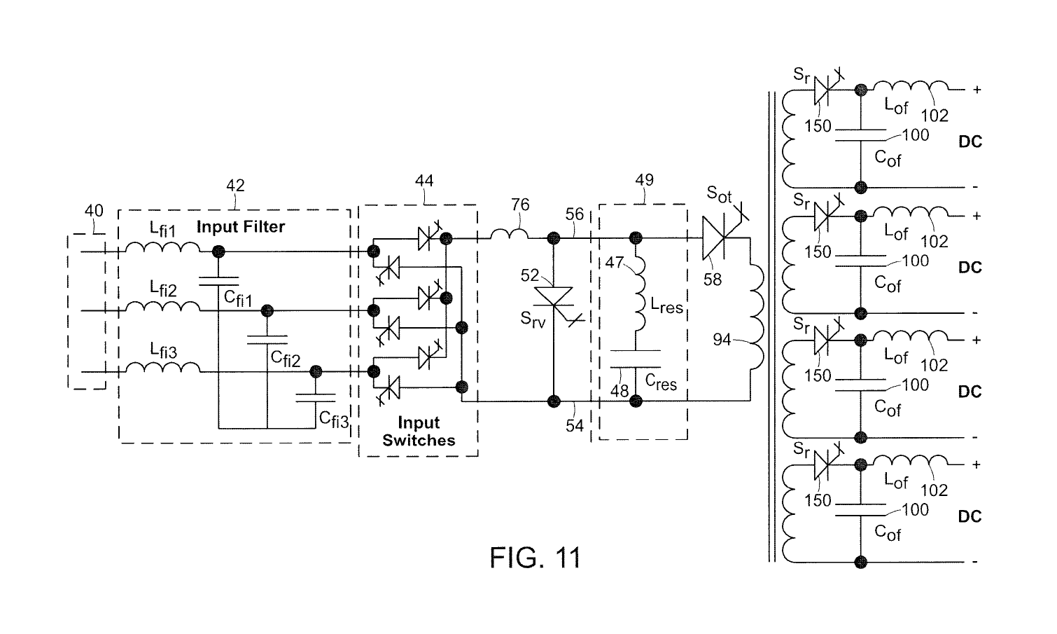

FIG. 11 shows a major power electronic component for a number of galvanic isolated and regulated. DC power sources. This is a typical application for the R-Link converter, drawing unity power factor AC input power with a Total Harmonic Distortion (THD) of the order of 1 to 2% with an inverter frequency in the range of 6 to 12 kHz. This frequency range is compatible with available power electronic switches in terms of voltage and currents. One such application of the component of FIG. 11 is a DC power source for multi-level high power variable speed drives. Other applications may be for multiple isolated DC circuits for a number of commercial or military applications. This is equivalent for the DC application or AC power distribution system with multiple isolated low frequency transformer windings. In such applications, for AC outputs, an AC switching section and filter are required.

The system can operate with either or both of the AC front end and DC output. The front end would not only control the power throughput but also the AC input power factor. This permits the R-Link to inject a desired reactive power that is beneficial for the grid system. This VAR level can be ordered by a remote control system with a R-Link bandwidth of the order of 200 Hz. This bandwidth is not only beneficial to control the reduction of overall reactive power but can be used for AC system instability control and local AC voltage regulation requirements without any degradation of the converter's primary function.

By transitioning directly from the charge to the discharge operation the Lᵣₑₛ−Cᵣₑₛ rail voltage 54, 56 is limited, allowing operating with a minimum voltage rating for all primary and secondary switches. For boost mode operation, the reversal switch Sᵣᵥ 52 is added. If the magnitude of all DC outputs is the same, the secondary rectification switch Sᵣ 150 can be replaced with a diode. Also if different DC voltages are required, the magnitude of the output voltage or total power throughput is regulated with the left switching section 44. However, with the use of the active output switches Sᵣ 150, the power for each output winding can be selected or completely turned off.

One of the near term applications of the circuit topology of FIG. 11 is to generate any number of isolated DC power sources for Multi-Level PWM variable speed variable speed motor drives (VSD). Such VSD benefit from an adjustable DC buss voltage in terms of efficiency

For a resistive load, an output filter inductor L_{of} 102 is added. However that inductor is not needed for a multi-level drive, and the output filter capacitor C_{of} 100 has to be sized to meet the drive's DC bus ripple requirements.

It should be further added that the optimum converter frequency is not defined by the switches but by other components. For transformer operation the core can be significantly reduced by the higher frequency, however as the core size reaches about 1% of the 60 Hz transformer, no further core reduction seems to beneficial to the system, since the windings (preferentially Litz wires) become more lossy and circuit inductance causes limitations. Therefore, the frequency for each converter depends on the application, power level, voltage, and other factor such as thermal management. It follows that each system needs to be optimized with a comprehensive design practice. Faster SiC switches are not necessary better since for the R-Link Si switch losses are not an issue. However SiC are attractive for high voltage operation since fewer switches are needed in series and the thermal heat can be rejected at higher ambient temperature without switch de-rating.

The simplified circuit of FIG. 11, having only a unidirectional input with a Cᵣₑₛ charge followed by a discharge can cause transformer core saturation. Additional circuit components can be added to control and reset the core magnetization. This is further addressed in U.S. Pat. No. 8,000,118 B1, and a number of control options are outlined.

### 9 VAR Compensator and Multi-Port

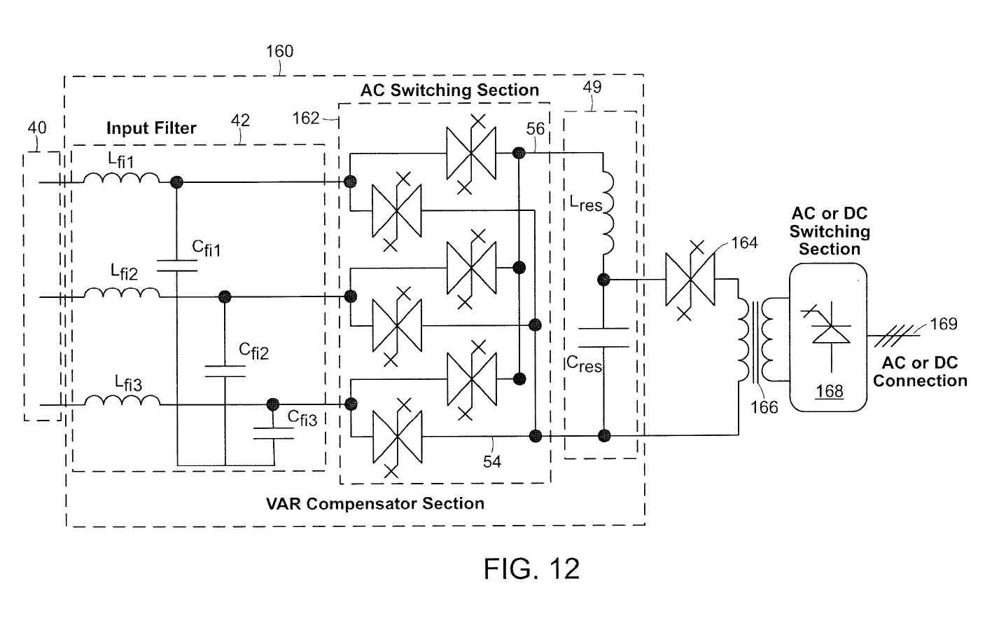

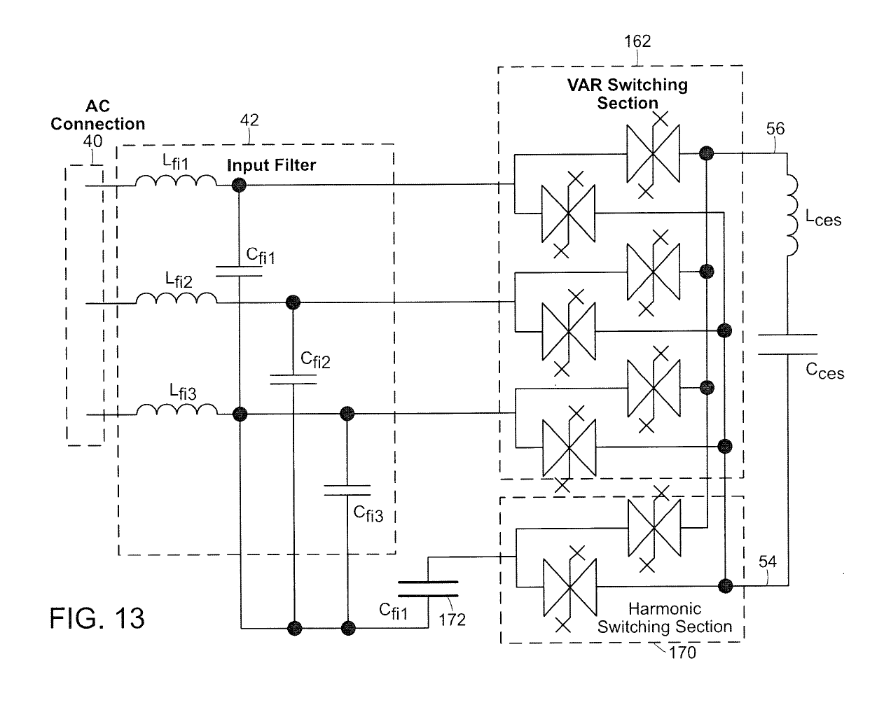

The resonant VAR compensator operation can also be modified to limit the switch or “rail” voltage with continuous operation. The circuit is operated with an equivalent zero voltage as described previously and illustrated in FIG. 6. The circuit shown in FIG. 12 can operated at leading 90 electrical degrees or lagging 90 electrical degrees to simulate either a capacitor band or inductor bank. The voltage in the Cᵣₑₛ capacitor changes the polarity between the charge interchange operations, with no net energy transferred between the AC input and the Cᵣₑₛ capacitor, with the exception of making up for the losses. The reactive current is proportional with the absolute Cᵣₑₛ voltage and the R-Link repetition frequency. By increasing the Cᵣₑₛ Voltage the reactive current or reactive power can be regulated over a large range. By going from one charge interchange cycle to the next charge interchange cycle, the rail voltage 54, 56 is clamped between the voltage defined by the AC terminal.

The system can be designed for a voltage swing that is much higher than the AC input voltage. The same VAR circuit topology is described by the '678 patent. However, the associated control system requires that for increased Cᵣₑₛ voltage swings the voltage rating increases proportionally. This is not the case for the previously described R-Link circuit topology since by switching from one charge interchange cycle to the next, the bi-directional input switches will only see the increased current and not the voltage. It follows, that the switch voltage rating from the '678 topology can be reduced by over 40% with the R-Link system, while the voltage swing also can be increased by ten-fold with the lower voltage switches. The higher voltage swing yields a larger controllable VAR power range that increases overall system flexibility.

Referring to FIG. 12, a simplified VAR compensator circuit 160 with the utilization of AC switches is illustrated. The simplified version of the “AC switch”, as defined by the back-to-back IGBTs 140 as shown in FIG. 10, are connected in parallel to the Lᵣₑₛ−Cᵣₑₛ resonant circuit 49.

Not shown on the schematics are the communication inductors 74 and “rail” voltage limiter 80 as introduced in conjunction with FIG. 5.

To the right of the VAR compensator section of FIG. 12 a second R-Link port is added with an “AC-Switch” 164, high frequency transformer 166, and switching section 168. This gives the option for a number of functions such as connecting to a galvanic isolated AC terminal or DC terminal 169 for energy storage and power injection into the grid. For proper resonant operation the transformer 166 not only provides the galvanic isolation and voltage transformation but is also wound such that the leakage inductance would provide the desired resonant period for the charge exchange with the AC or DC power terminals 169.

A typical VAR compensator has the option of VAR control to improve the power factor, voltage regulation, and if the bandwidth is sufficiently high can control the voltage flicker. However, the voltage support is limited, since no power is added. For a number of applications such as renewable energy, the VAR support alone is not sufficient to stabilize the input terminal voltage 40. The added circuit has the capability of drawing power off the grid if the voltage is high and storing that energy in a number of electric storage devices. On the other hand if the input voltage is low, and the VAR injection is not sufficient, power can be re-injected into the grid. The power stored power may come from batteries, flywheels, or from a number of DC or AC power sources.

This VAR compensation, energy storage, and power support system has many facility and utility grid application and is useful not only for fluctuating loads but also for fluctuating power generation such as wind, solar, wave, and power injection into the grid by small power provider.

The VAR control is simpler, since it is only a two-step operation. The three switches for each charge interchange are identified by the three switches that is required to support the VAR current. The primary phase is identified by the highest instantaneous current. The initial and final central capacitor voltage is given by;

|Iₚ/(ω₀t)/τp|=|Qₚ|=2Cₒ|V_{cof}|=|(Qₛ+Qₜ)| (19)

The primary line current and therefore the reactive power is proportional to the initial and final Cᵣₑₛ voltage. Therefore, the V_{cof} voltage control controls the reactive power flow. The operation starts at “t₀” with the primary and secondary terminals voltage of Vₚₛ with energy transfer into the secondary phase. Triggering the tertiary switch at “t₁”, resulting in a Vₚₜ voltage connection, start the energy transfer from the tertiary phase in the Cᵣₑₛ capacitor. With the correctly timed triggering, the Cᵣₑₛ capacitor will be recharged to the negative value of the initial V_{cof} voltage, neglecting circuit losses. If we trigger before “t₁” the discharge process is reduced, while the recharge time is increased, resulting in an increase of the final V_{cof} voltage and vice-versa. As soon as the current goes to zero, the reverse polarity V_{co} starts, with a V_{co} voltage back to the original V_{cof} voltage. Since the current in the Cᵣₑₛ−Lᵣₑₛ flows in the opposite direction, the opposite polarity switches are selected, in such a way that the induced phase current is in the same direction. Therefore, one only requires to compute the “t₁” time that can be given by computing or using the V_{cos} voltage at “t₁”. Equation 20 can be solved for “t₁”.

V_{cos}(t)=V_{cof}(1+2(Iₛ(ωt)/Iₚ/(∫t₁)) (20)

Using the resonant procedure we obtain a trigonometric expression, similar to that of equation 13 and solve for ω₀t₁. The typical range is π/2>ω₀t₁>π

### 10 Harmonic Mitigation

With the exception of the zero sequence harmonics, the remaining harmonics cause instantaneous power fluctuation on the grid. Since the basic R-Link circuit does not store power in the central capacitors, an additional port such as a battery bank or capacitor bank, can be added to take the excess energy off the grid and re-inject it when the power is lower than the a average.

For complete VAR control with continuous operation, the central capacitor is reversed twice per VAR cycle. One reversal uses two operations, discharge the Cᵣₑᵥ capacitor between the primary and secondary with the second operation recharging the capacitor between the primary and tertiary. This gives, for a full cycle four operation with no net energy change in the converter system.

Referring to FIG. 13, a modification to the basic R-Link VAR compensator adds an additional fourth input switching section 170 using two AC-Switches and an energy storage element in the form of a capacitor C_{fh} 172. This switching section is connected across the 54, 56 converter rails. This additional port has only a filter capacitor with no inductors and input terminal. For the two step Cᵣₑₛ capacitor reversal cycle, an additional cycle is added that either drives energy into the C_{fh} 172 harmonic energy storage capacitor or retrieves energy depending on the harmonic filtering requirement. This converts the two step R-Link VAR operation to a three step VAR and harmonic filtering operation. If the capacitor value is sufficiently large, all the excess energy storage needed for the full harmonic compensation and subsequent energy release to fill in the typical energy notches during a typical AC cycle is present.

For harmonic compensation with the R-Link VAR compensator circuit of FIG. 12 the reactive current requirements for AC are modified by adding the instantaneous sum of the harmonics current amplitude. Multiplying each of the three instantaneous phase current with the respective line voltage will yield the energy per pulse that needs to be absorbed or supplied by the C_{fh} filter capacitor. With the measured V_{cfh} voltage, the sequencing of the harmonic switch operation can be defined. For system energy reduction, the C_{fh} is sequenced in during the Cᵣₑₛ discharge process following the high to low rule, while for the energy absorption requirement, the C_{fh} is sequenced in during the recharging process of Cᵣₑₛ. The timing and sequencing is ideally pre-calculated and stored in lookup tables to minimize the real time computing process. However, additional DSP computation may be used to optimize the harmonic filtering process.

Such an operation is soft switching independent of the C_{fh} capacitor voltage. This would permit the operation of the converter in the range of 20 kHz frequency with a total 40 kHz ripple on the inverter filter input with present day silicon switches. The frequency may be increased with more modern switches, once they become commercially available. This applies for all R-Link operation.

For the 20 kHz inverter operation we could set the converter input cut-off frequency at 12 kHz. This would give us the option to address harmonic disturbances well above the 25th harmonic for a 60 Hz AC grid. This bandwidth is more than satisfactory for most utility or clean power applications.

The implementation of the dummy four-terminal AC system, introduced for the R-Link VAR compensator may be used for practically all of the R-Link AC ports.

### 11 Segmented Resonant Circuit Options

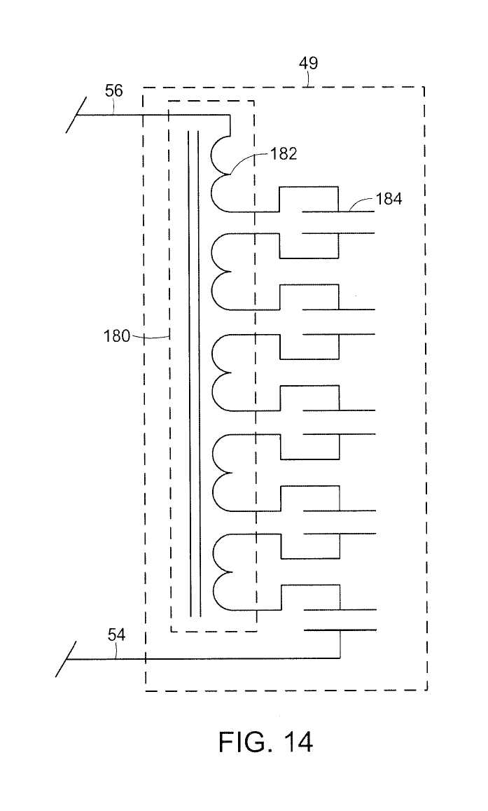

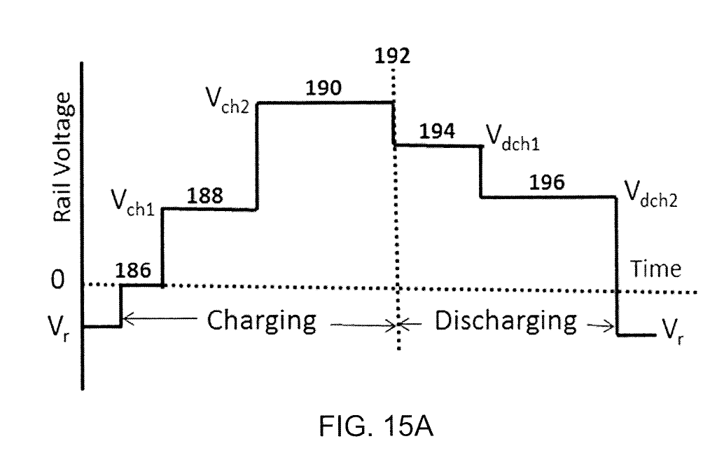

Referring to FIG. 4, for higher voltage R-Link circuit topologies with higher frequency operation, the C_{ref} 46 capacitor is constructed of a number of individual parallel and series connected smaller capacitor elements. It is therefore optional to construct this capacitor bank with lower voltage capacitors section 184 in series with individual inductor windings 182 for low voltage section. These sections are placed in series and yield the voltage requirements of the full voltage resonant requirements 184. The individual inductor windings, as shown in FIG. 14 are coupled through the magnetic core, however more than one core may be used, depending on the high voltage design and packaging requirements.

Each capacitor-winding section can have its own active or passive voltage limiter as introduced in FIG. 5. Simple inspection shows that the topology of FIG. 14 has limited voltage hold-off requirement per stage and a voltage hold off requirement with respect to ground that is of the order of the rail voltage or less. The benefits and flexibility are apparent to individuals skilled in high voltage and high power systems.

### 12 R-Link Sequencing for Soft Switching Operation

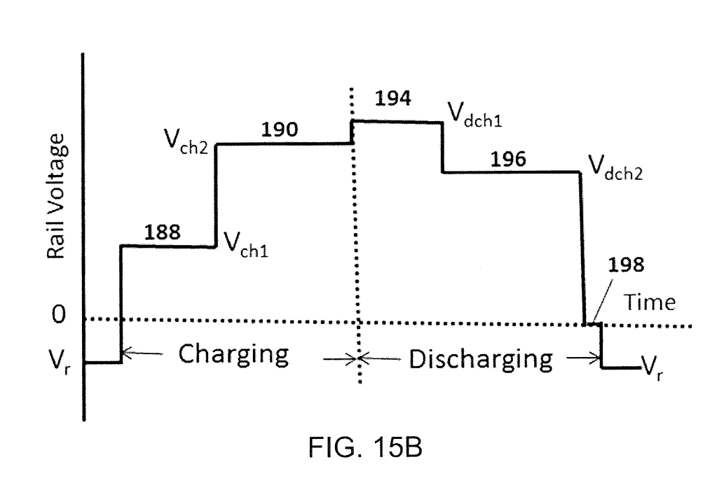

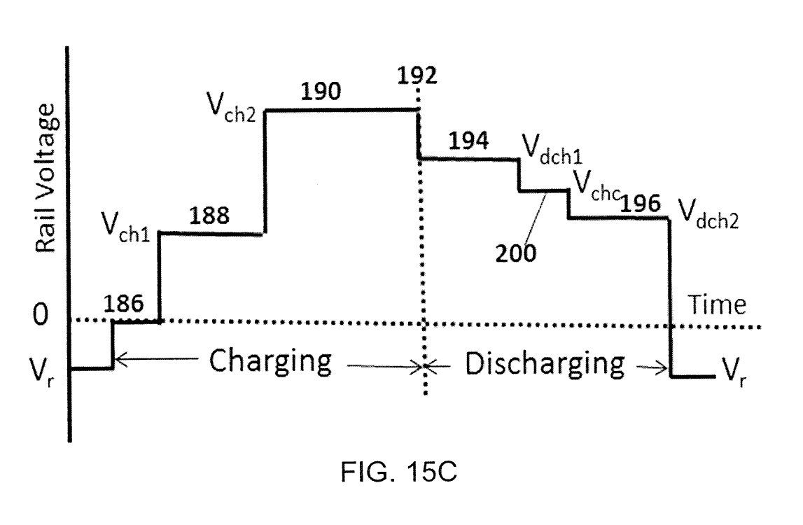

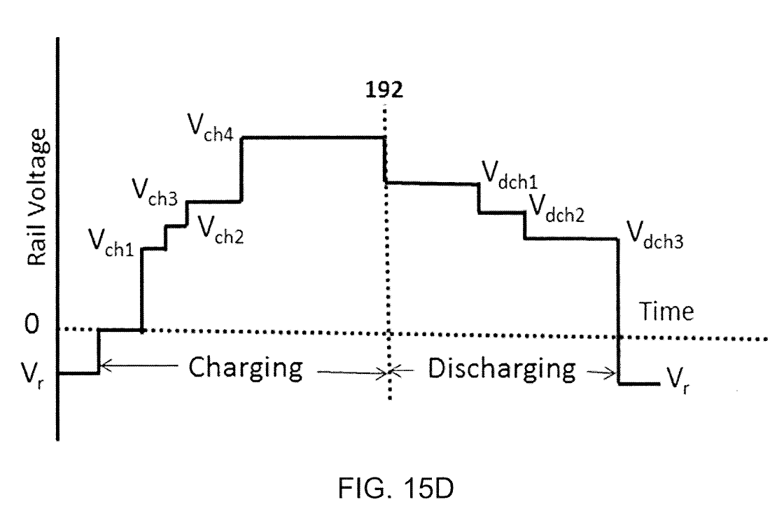

FIGS. 15a-d are provided to graphically illustrate the sequencing of the R-Link operation. The x-axes represent time and the y-axes represent the qualitative voltage level that is applied across the resonant circuit. FIG. 15a illustrated the AC-AC buck-mode operation starting out with a negative residual voltage V, with a negative residual voltage. This is the Cᵣₑₛ capacitor voltage, since no current is flowing and the resonant circuit is open. Turning on the inversions switch the “rail” voltage between the terminal 54 and 56 becomes zero 186. As the primary and secondary inputs are connected the voltage steps up to V_{ch1} 188. To complete the charge cycle the higher primary-tertiary voltage V_{ch2} 190 is connected to the rail. The charge cycle is complete once the current goes to zero at 192.

At this point the discharge cycle is initiated with the turn-on of the primary and secondary outputs connect with a voltage level of V_{dch1} 194. The operation is continuous, such that the rail voltage does not jump up to the full Cᵣₑₛ voltage at 192. If the V_{dch1} 194 is lower than the V_{ch2} 190 the discharge can be triggered with an overlap of the charging-discharge period. Finally the tertiary output switch is triggered, resulting in a reduction of the rail voltage to V_{dch2} 196. As the discharge comes to completion and the switches are back-biased the rail voltage sees the residual voltage Cᵣₑₛ. The next charge cycle can be initiated at this point with any selected delay.

Referring to FIG. 15b, the boost mode operation is similar. However, with the residual voltage skipped and the reversal operation added at the end of the discharge. The discharge is terminated with the triggering of the reversal switch forcing the rail voltage from V_{dch2} 196 to zero at 198. For both the buck and boost mode operation, we only use soft switching with the voltage increasing during the charge operation and decreasing during the discharge operation. If DC is used use for either the input or output the operation is simplified.

Referring to FIG. 15c, the same buck-mode similar to an AC-AC operation is shown with a modification to the discharge mode. A new output voltage level of V_{ac} 200 is added with a voltage level in the range of V_{dch1}>V_{chc}>V_{dch2}. The voltage level V_{chc} may be any power terminal connection. It may be a DC power terminal connected to a DC energy storage with the objected in this cycle to divert some of the input energy into a DC energy storage system, while the rest of the energy is transferred to the AC output. This energy diversion is not limited to a terminal voltage of V_{dch1}>V_{chc}>V_{dch2} it may be at any voltage including larger than V_{dch1} or lower than V_{dch2}. The only requirement for soft switching would be reorder the discharge with a sequential terminal voltage from high to low. The output may not necessarily be a three-phase AC output terminal with a DC storage, it could also be three individual output terminals of a three-phase output terminal for an unbalanced AC load. The same sequence could be used for three individual DC outputs with different voltages and different power requirements. The charge transfer would be regulated by the load connection timing.

Referring to FIG. 15d, another charge and discharge sequence, with a number of charge and discharge sequences is shown. The voltage levels in the charging process incrementally increase while the voltage levels for the discharges incrementally decrease. Energy is delivered to the rail and transferred to the resonant circuit by the power terminals on the left side of FIG. 15, while the energy is delivered to the power terminals on the right side of FIG. 15. It is obvious that a number of power sources and a number of loads may be addressed during a single charge and discharge sequence. This type of power converter electronics, with proper control implementation, is useful in a multitude of applications. The use of a practical implementation is the energy storage capacitor C_{fh} 172 of FIG. 13 for the VAR compensator with harmonic mitigation. For this type of function the energy storage capacitor is sequenced into on the left side of 192 for energy injection and on the right hand side for energy extraction from the rail terminals.

### 13 Diagnostics, Fault Protection, and Control

Reliable R-Link operation requires the following major components. First the power electronic components need to be selected or designed for reliable long term operation with proper thermal management. Secondly, the control system is key such that the power electronics are operated in a reliable operating range. And third, with the high frequency of operation, the system requires a comprehensive operational monitoring and fault protection system that can respond without delay to take automatic action such that a component fault or unusual power grid condition does not result in power electronic failures or high short current condition.

Some of the fault protection may be passive such as MOV's, however, it is crucial, that at least some of the fault protection is active, shifting the mode of operation, or shutting down the operation in a controlled way.

A number of fault monitoring steps are taken for every R-Link sub-cycle. Switches will not be closed, if specific current readings are detected. Also switches will not be opened under current, since the inductive kick could damage a number of active or passive components.

The currents and voltages for the input, output, and across power electronics are monitored. The control system, upon the initial installation, is adjusted for phasing and a number of selected operations are performed to fully check the diagnostics. Knowing the component values, it self-calibrates each critical measurement channel that is used by the system controller. It also knows what the voltage and current limits are and uses them for the self-protection determination.

Fault protection is key for successful R-Link operation and monitoring a large numbers of time the during a single R-Link cycle. For each section of the R-Link sequence only a few current monitors should have non-zero current, while other monitors most have current over a specific threshold. Furthermore the current drawn has to be below a defined level. These operational metrics can be instantaneously compared with the correct operating metrics and a proper fault protection action can be defined. A positive fault detection may be a result of an operating logic error, an instrumentation issue, a component failure, or a load fault. The action may result in a complete automatic system shutdown followed by a system recalibration, testing of specific component failure, and output load fault testing. If the load fault is clear and the self-test finds the system operational, the system can be automatically restarted.

The design of the control system utilizes analog, digital signal processing, and programmable logic control such a FPGA. Since the system operating is clearly defined, an FPGA performs most of the work, using the FPGA programmed logic with the addition of a number of lookup tables. These tables define the specific timing requirements for the required power level, frequency, phase shift, and other operational parameters. The FPGA also performs most of the fault detection.

An operational DSP a supervisory role, digesting most of the measured A/D data, and performing detailed computation to refine the lookup data or shift the converter operating requirements. It is understood that the functional division can be shifted as the capability of FPGAs improve.

Analog computational capability should not be ignored, since signal addition, comparison, multiplication and taking the square root and filtering and are instantaneous. These analog functions can for some applications add reliability, simplicity, and a reduction of cost. Some examples of analog functions include instantaneously measuring the three phase RMS voltage, RMS current, and measuring reliable zero crossing on any AC phase in the present line frequency noise.

The controller's communication input and trigger system output is best performed over fiber optics (FO) to isolate and shield the control system from system noise. This is especially important during a load or high power system fault. Some of the FO connection may be connected to parallel module for timing synchronization and operation coordination.

It is also preferential to have a second small and dedicated master DSP to interface with the system operator over a high speed data protocol system. This system will not only get the operating order, but also download continuous operational data. This master DSP should have the capability to download operational DSP's and FPGA code modification to update the system for up to date operation.

### 13.1 Vector Control

Most large three-phase motors are induction motors which are driven by converters for speed control and power reduction. For such applications, the R-Link converter is a highly suitable variable speed drive, since it not only can control induction motors with the same average current and required frequency, but it also applies drive power at a low dV/dt thereby generating lower EMI, higher motor winding life, and no bearing degradation. In general, conventional voltage source converters require that AC input power is first rectified such that relatively clean DC power is provided to the motor. The R-link on the other hand eliminates the AC to DC rectification step and draws power at low THD.

For applications such as pump control and similar applications where motor speed is only slowly varied, a standard “scalar control” is used with a relatively constant motor voltage to frequency ratio. However, for phase acting motor drives, number Space Vectors or Field Orientated controls are used with the standard voltage-source PWM converter. These systems typically have a torque control defined by the supplied motor current and speed control defined by the supplied frequency.

The R-Link converter is basically a current source converter that can be operated using either a DC input power source or directly using an AC input power source without having to perform an AC to DC rectification process. In can directly control a variable speed motor using standard scalar variable speed control. Furthermore, since it is basically a current source it can be programmed as a Space Vector controller with the current amplitude providing the toque control and the output frequency a speed control.

In addition, the AC to AC R-Link converter is a bidirectional converter, such that it also can used for fast dynamic breaking and fast rotational directional speed control. Space Vector technology has been well developed over the last 20 years and standard Space Vector control is fully applicable for R-Link operation with minimum adoption effort.

It is to be understood that the foregoing description is intended to illustrate and not to limit the scope of the invention, which is defined by the scope of the appended claims. Other embodiments are within the scope of the following claims.

What is claimed is:

1. A method of transferring electric charge between a first power terminal having a plurality of first-nodes and a second power terminal having a plurality of second-nodes, said method comprising:
interchanging charges between a first first-node of the plurality of first-nodes with a resonant circuit, the resonant circuit including a storage device and a series connected inductive section;
when a predetermined charge has been interchanged between the first first-node and the resonant circuit, replacing the first first-node by a second first-node of the plurality of first-nodes and interchanging charges between the second first-node and the resonant circuit;
when a predetermined charge has been interchanged between the second first-node and the resonant circuit, replacing the second first-node by a first second-node of the plurality of second-nodes;
when a predetermined charge has been interchanged between the first second-node and the resonant circuit, replacing the first second-node by a second second-node of the plurality of second-nodes and interchanging charges between the second second-node and the resonant circuit.

2. The method of claim 1 further comprising:
configuring the first power terminal as an AC power terminal and configuring the second power terminal as an AC power terminal.

3. The method of claim 1, wherein the first power terminal and the second power terminal are the same power terminal.

4. The method of claim 1, wherein the first power terminal includes a first plurality of power terminals, the second power terminal includes a second plurality of power terminals, and
interchanging charge between the resonant circuit and the first power terminal includes interchanging charge between any of the power terminals of the first plurality of power terminals and the resonant circuit, and
interchanging charge between the resonant circuit and the second power terminal includes interchanging charge between any of the power terminals of the second plurality of power terminals and the resonant circuit.

5. The method of claim 1, where a passive voltage limiter is connected in parallel to the resonant circuit.

6. The method of claim 1, where an active voltage limiter is connected in parallel to the resonant circuit.

7. The method of claim 1, wherein a ratio of the predetermined charge interchange between the resonant circuit and the first second-node and the charge interchange between the resonant circuit and the second second-node is equal to a ratio of the current injected into the first second-node and the second second-node.

8. The method of claim 1, further comprising:
interchanging charge between the first and second power terminals and a second resonant circuit,
wherein the second resonant circuit is sized to store sufficient energy to serve as an energy sink and source for a plurality of charge interchanges.

9. The method of claim 1 further comprising controlling a total charge interchange from the first terminal to the resonant circuit by adding an additional charge interchange with a low voltage source, preceding the charge interchange between the resonant circuit and a first first-node of the plurality of first-nodes; when a predetermined charge has passed through that low voltage source, replacing the low voltage source with that of the first first-node.

10. The method of claim 1 further comprising controlling a total second terminal charge interchange with the resonant circuit by adding an additional charge interchange with a low voltage source, when a predetermined charge has passed through second second-node replacing the second second-node with that of a low voltage source.

11. A charge transfer apparatus comprising:
an inductive section;
an energy storage device coupled in series with the inductive section to a resonant circuit;
a first power terminal having a plurality of first nodes;
a plurality of first switches coupling the first power terminal with the resonant circuit;
a second power terminal having a plurality of second nodes;
a plurality of switches coupling the second power terminal with the resonant circuit;
a control unit for controlling the operation of the plurality of first switches to interchange a first predetermined amount of charge between a first node of the plurality of first nodes and the resonant circuit and to interchange a second predetermined amount of charge between a second node of the plurality of first nodes and the resonant circuit,
wherein a ratio of the first predetermined amount of charge interchanged between the resonant circuit and the first node and the second predetermined amount of charge interchange between the resonant circuit and the second node is equal to a ratio of the currents drawn from the first node and the second node; and
a control unit for controlling the operation of the plurality of second switches to interchange a first predetermined amount of charge between a first second-node of the plurality of second nodes and the resonant circuit and to interchange a second predetermined amount of charge between a second second-node of the plurality of second nodes and the resonant circuit,
wherein a ratio of the third predetermined amount of charge interchanged between the resonant circuit and the first node and the fourth predetermined amount of charge interchange between the resonant circuit and the second node is equal to a ratio of the currents delivered to the first node and the second node.

12. The charge transfer apparatus of claim 11, wherein the control unit directly transitions the charge interchange between the series resonant circuit and the first nodes to the charge interchange between the series resonant circuit and the second nodes.

13. The charge transfer apparatus of claim 11, wherein the first power terminal is configured to receive a multi-phase power supply and the second power terminal is configured to supply a multi-phase power load.

14. The charge transfer apparatus of claim 11, wherein the control unit operates the plurality of second switches to reconstruct an AC waveform on the second power terminal.

15. The charge transfer apparatus of claim 11, wherein the first power terminal is configured to receive a multi-phase AC power supply, and the control unit operates the plurality of switches to produce an average current described in a Fourier series.

16. The charge transfer apparatus of claim 11, wherein the first power terminal and the second power terminal are the same and coupled to an AC grid, and the control unit operates the plurality of first switches and the plurality of the second switches to control the reactive current flow to the AC grid.

17. The charge transfer apparatus of claim 11 wherein an inversion switch is placed across the resonant circuit and wherein the control unit triggers the inversion to cause a current flow in the resonant circuit prior to the charge interchange with the first power terminal.

18. The charge transfer apparatus of claim 11 wherein a reversal switch is placed across the resonant circuit, and the control unit triggers the reversal switch to cause a current flow between the resonant circuit and the reversal switch, terminating the charge interchange between the resonant circuit and the second power terminal.

19. The charge transfer apparatus of claim 11 further comprising a transformer between the resonant circuit and the plurality of second nodes connecting the plurality of switches between the resonant circuit and a primary winding of the transformer; wherein the transformer secondary is connected to the switches of the second power terminal, and the control system operates the switches in conjunction with the plurality of the second switches.

20. The charge transfer apparatus of claim 19 wherein the first power terminal is configured to receive a multi-phase power supply and the second power terminal is configured to supply a multi-phase power load.

21. The charge transfer apparatus of claim 19 and a transformer with multiple secondary winding and; where each winding is configured as separate power source; and where the control system controlling the charge transfer to the plurality of power sources.

22. The charge transfer apparatus of claim 19, wherein using a plurality of switches between the resonant circuit of the primary transformer winding; and using a control system that switches the resonant circuit to the primary winding periodically reversing the polarity of the primary transformer winding and with it the flux in the transformer core.

23. The charge transfer apparatus of claim 11 wherein using a plurality of primary transformer winding; and using a control system to switch the resonant circuit periodically to alternate the current in that plurality of that windings and with it alternate the flux in the transformer core.

24. The charge transfer apparatus of claim 18 further comprising a transformer with a plurality of primary windings and a plurality of resonant circuits, each including a dedicated plurality of first switching the resonant circuit to a primary winding of the plurality of primary windings, wherein the winding direction is such that the flux in the core is periodically reversed; and a control system that alternately charges and discharges the resonant circuit of the plurality of resonant circuits and alternately discharges the resonant circuit into the primary of the primary transformer windings.

25. An apparatus for transferring electric charge between a power source and a power sink having a second plurality of terminals, the method comprising:
a first plurality of terminals connected to the power source;
a second plurality of terminals connected to the power sink;
a resonant circuit including a charge storage element connected in series with an inductive element;
a plurality of input switches disposed between the first plurality of terminals and the resonant circuit;
a plurality of output switches disposed between the resonant circuit and the second plurality of terminals; and
a controller configured to:
activate the plurality of input switches according to a first switching sequence such that charge is transferred from the first plurality of terminals to the resonant circuit by causing different pairs of the first plurality of terminals to be electrically connected to the resonant circuit at different times, and
activate the plurality of output switches according to a second switching sequence such that charge is transferred from the resonant circuit to the second plurality of terminals by causing different pairs of the second plurality of terminals to be electrically connected to the resonant circuit at different times;
wherein upon completion of transferring charge from the first plurality of terminals to the resonant circuit, a first voltage exists on the charge storage element and while transferring electric charge between the first power terminal and the second power terminal, a maximum voltage applied to the plurality of input switches and the plurality of output switches is less than the first voltage.
